(19) United States
(12) Patent Application Publication
(10) Pub. No.: US 2024/0373403 A1
(43) Pub. Date: Nov. 7, 2024

(54) METHOD AND APPARATUS FOR PAGING

(71) Applicant: Telefonaktiebolaget LM Ericsson (publ), Stockholm (SE)

(72) Inventor: Zhang Zhang, Beijing (CN)

(21) Appl. No.: 18/687,197

(22) PCT Filed: Aug. 12, 2022
(86) PCT No.: PCT/CN2022/112105

§ 371 Date: Feb. 27, 2024

(30) Foreign Application Priority Data
Sep. 10, 2021 (WO) PCT/CN2021/117769

(51) Int. Cl. H04W 68/02; H04W 36/00; H04W 76/27; H04W 88/04

(52) U.S. Cl. CPC H04W 68/02; H04W 36/03; H04W 76/27; H04W 88/04

(57) ABSTRACT

Various embodiments of the present disclosure provide a method for paging. The method which may be performed by a first user equipment comprises generating first frequency information. The first frequency information may indicate one or more frequencies of the first UE. In accordance with an exemplary embodiment, the method further comprises transmitting the first frequency information to a second user equipment.

### FIELD OF THE INVENTION

The present disclosure generally relates to communication networks, and more specifically, to a method and apparatus for paging.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the evolution of wireless communication, a requirement for supporting device-to-device (D2D) communication features in various applications is proposed. An extension for the D2D work may consist of supporting vehicle-to-everything (V2X) communication, which may include any combination of direct communications among vehicles, pedestrians and infrastructure. Wireless communication networks such as fourth generation (4G)/long term evolution (LTE) and fifth generation (5G)/new radio (NR) networks may be expected to use V2X services and support communication for V2X capable user equipment (UE).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In a wireless communication network, direct unicast transmission over a sidelink (SL) between two V2X capable UEs may be needed in some applications such as platooning, cooperative driving, dynamic ride sharing, etc. For a remote UE in the network (NW), e.g., a UE that may be out of cell coverage and may not be able to connect with a network node directly, a UE-to-NW relay UE (also called U2N relay for short) may provide the functionality to support connectivity to the NW for the remote UE. In this case, uplink/downlink (UL/DL) traffics of the remote UE may be forwarded by the U2N relay. In some cases, the remote UE may communicate with another UE via one or more UE-to-UE relay UEs (also called U2U relays for short), and various traffics of the remote UE may be forwarded by the one or more U2U relays. In a UE-to-NW relay scenario, a base station may not be able to reach the remote UE through a paging message because the base station may page the remote UE on a Uu frequency that the remote UE camps on or supports, but this Uu frequency is different from a Uu frequency that the relay UE camps on or supports. Therefore, it may be desirable to support paging for a remote UE in a more efficient way.

Various exemplary embodiments of the present disclosure propose a solution for paging, which may enable a remote UE to be paged when the remote UE and a relay UE are camping on different Uu frequencies or the Uu frequencies that they support are not the same.

It can be appreciated that the “remote UE” described in this document may refer to a UE that may communicate with a relay UE e.g. via PC5/SL interface, and/or communicate with a network node e.g. via Uu interface. As an example, the remote UE may be a 5G proximity-based services (ProSe) enabled UE that may communicate with a data network (DN) via a ProSe 5G UE-to-NW relay UE. As another example, the remote UE may be a 5G ProSe enabled UE that may communicate with another UE via a ProSe 5G UE-to-UE relay UE.

It can be appreciated that the “relay UE” described in this document may refer to the “UE-to-NW relay UE” in a UE-to-NW relay scenario or the “UE-to-UE relay UE” in a UE-to-UE relay scenario. As an example, the relay UE may be a 5G ProSe enabled UE that is capable of supporting connectivity to the NW and/or other UE(s) for the remote UE.

It can be appreciated that the “UE-to-Network relay UE” described in this document may also be referred to as “UE-to-NW relay UE”, “UE-to-Network relay” and “UE-to-NW relay”. Thus, the terms “UE-to-Network relay UE”, “UE-to-NW relay UE”, “UE-to-Network relay” and “UE-to-NW relay” may be used interchangeably in this document.

It can be appreciated that a link or a radio link over which signals are transmitted between at least two UEs for D2D operation may be called in this document as the sidelink (SL). The signals transmitted between the UEs for D2D operation may be called in this document as SL signals. The terms “sidelink” and “SL” may also interchangeably be called as D2D link, V2X link, ProSe link, peer-to-peer link, PC5 link, etc. The SL signals may also interchangeably be called as V2X signals, D2D signals, ProSe signals, PC5 signals, peer-to-peer signals, etc.

It can be appreciated that the terms “direct connection” and “direct path” may be used in this document to stand for a connection between a UE and a network node such as a gNB, while the terms “indirect connection” and “indirect path” to stand for a connection between a remote UE and a network node such as a gNB via a relay UE. In addition, the term “path switch” as described in this document may refer to a situation when a remote UE changes between two paths (e.g., two direct paths, two indirect paths, or one direct path and one indirect path).

According to a first aspect of the present disclosure, there is provided a method performed by a first UE. The method comprises: generating first frequency information. The first frequency information may indicate one or more frequencies of the first UE. In accordance with an exemplary embodiment, the method further comprises: transmitting the first frequency information to a second UE.

In accordance with an exemplary embodiment, the first frequency information may be transmitted to the second UE in a discovery message.

In accordance with an exemplary embodiment, when the first UE is linked to the second UE, the first frequency information may be transmitted to the second UE proactively or in response to a request from the second UE.

In accordance with an exemplary embodiment, the first UE may operate as a remote UE, and the second UE may operate as a relay UE for the first UE.

In accordance with an exemplary embodiment, the one or more frequencies of the first UE may comprise: one or more Uu frequencies which the first UE camps on when the first UE is in a radio resource control (RRC) idle/inactive state; and/or one or more Uu frequency bands which the first UE is able to support for paging.

In accordance with an exemplary embodiment, the method according to the first aspect of the present disclosure may further comprise receiving, from the second UE, one or more of:
second frequency information indicating one or more frequencies of the second UE;
an indication of whether the one or more frequencies of the first UE are overlapped with the one or more frequencies of the second UE;
an indication of whether the second UE is able to monitor paging for the first UE; and
an indication of one or more frequencies in which the second UE is able to monitor the paging for the first UE.

In accordance with an exemplary embodiment, the one or more frequencies of the second UE may comprise: one or more Uu frequencies which the second UE operates on; and/or one or more Uu frequency bands which the second UE is able to support for paging.

In accordance with an exemplary embodiment, the method according to the first aspect of the present disclosure may further comprise: deprioritizing the second UE in relay selection or reselection by the first UE, when the one or more frequencies of the first UE are not overlapped with one or more frequencies of the second UE.

In accordance with an exemplary embodiment, the method according to the first aspect of the present disclosure may further comprise: triggering a relay reselection procedure to select another relay UE for the first UE and/or a cell reselection procedure to select a cell for the first UE, when the second UE is not able to monitor paging for the first UE.

In accordance with an exemplary embodiment, the method according to the first aspect of the present disclosure may further comprise: transmitting event information to the second UE. The event information may indicate that no other relay UE being able to monitor the paging for the first UE is selected by using the relay reselection procedure, and/or that no cell is selected for the first UE by using the cell reselection procedure.

In accordance with an exemplary embodiment, the method according to the first aspect of the present disclosure may further comprise: entering an RRC connected state from an RRC idle/inactive state, when an event persists for a predetermined period. In an embodiment, the event may include that no other relay UE being able to monitor the paging for the first UE is selected by using the relay reselection procedure, and/or that no cell is selected for the first UE by using the cell reselection procedure.

In accordance with an exemplary embodiment, the method according to the first aspect of the present disclosure may further comprise transmitting, to a base station, information about one or more of:
whether the first UE is able to find a relay UE which is able to monitor paging for the first UE and has PC5 link quality higher than a first threshold;
whether the first UE is able to find a cell which has Uu link quality higher than a second threshold; and
whether one or more relay UEs included in a measurement report of the first UE are able to monitor the paging for the first UE.

In accordance with an exemplary embodiment, the method according to the first aspect of the present disclosure may further comprise: receiving, from a base station, information about a first list of relay UEs and/or a second list of relay UEs. In an embodiment, the first list of relay UEs may include one or more relay UEs available for the first UE in an RRC idle/inactive state, and the second list of relay UEs may include one or more relay UEs not available for the first UE in an RRC idle/inactive state.

In accordance with an exemplary embodiment, the first UE may operate as a relay UE for the second UE, and the second UE may operate as a remote UE.

In accordance with an exemplary embodiment, the one or more frequencies of the first UE may comprise: one or more Uu frequencies which the first UE operates on; and/or one or more Uu frequency bands which the first UE is able to support for paging.

In accordance with an exemplary embodiment, the method according to the first aspect of the present disclosure may further comprise receiving, from the second UE, one or more of:
second frequency information indicating one or more frequencies of the second UE; and
an indication of whether the one or more frequencies of the first UE are overlapped with the one or more frequencies of the second UE.

In accordance with an exemplary embodiment, the one or more frequencies of the second UE may comprise: one or more Uu frequencies which the second UE camps on when the second UE is in an RRC idle/inactive state; and/or one or more Uu frequency bands which the second UE is able to support for paging.

In accordance with an exemplary embodiment, when one or more Uu frequencies which the second UE camps on are not overlapped with one or more Uu frequencies which the first UE operates on, the method according to the first aspect of the present disclosure may further comprise: selecting to monitor paging for the second UE in the one or more Uu frequencies which the second UE camps on, when the one or more Uu frequencies which the second UE camps on are supported for paging by the first UE.

In accordance with an exemplary embodiment, the method according to the first aspect of the present disclosure may further comprise: transmitting an identifier of the second UE to a base station.

In accordance with an exemplary embodiment, the method according to the first aspect of the present disclosure may further comprise: selecting to monitor paging for the second UE in one or more Uu frequencies which the first UE operates on and/or are supported for paging by the first UE.

In accordance with an exemplary embodiment, when the first UE is not able to monitor paging for the second UE, the method according to the first aspect of the present disclosure may further comprise: receiving event information from the second UE. In an embodiment, the event information may indicate that no other relay UE being able to monitor the paging for the second UE is selected by using a relay reselection procedure of the second UE, and/or that no cell is selected for the second UE by using a cell reselection procedure of the second UE.

In accordance with an exemplary embodiment, the method according to the first aspect of the present disclosure may further comprise: starting to monitor the paging for the second UE, when the first UE becomes to be capable of monitoring the paging for the second UE.

In accordance with an exemplary embodiment, the first UE may communicate with the second UE by using one or more of:
RRC signaling;
PC5-S signaling;
discovery signaling;
a control element for medium access control (MAC CE);
a protocol data unit (PDU) of a protocol layer; and
physical layer (L1) signaling on sidelink channels.

In accordance with an exemplary embodiment, the first UE and/or the second UE may communicate with a base station by using one or more of:
RRC signaling;
a MAC CE;
a paging message;
a PDU of a protocol layer; and
L1 signaling.

According to a second aspect of the present disclosure, there is provided an apparatus which may be implemented as a first UE. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a first UE. The apparatus may comprise a generating unit and a transmitting unit. In accordance with some exemplary embodiments, the generating unit may be operable to carry out at least the generating step of the method according to the first aspect of the present disclosure. The transmitting unit may be operable to carry out at least the transmitting step of the method according to the first aspect of the present disclosure.

According to a fifth aspect of the present disclosure, there is provided a method performed by a second UE. The method comprises: receiving first frequency information from a first UE. The first frequency information may indicate one or more frequencies of the first UE. In accordance with an exemplary embodiment, the method further comprises: determining the one or more frequencies of the first UE, according to the first frequency information.

In accordance with an exemplary embodiment, the first frequency information may be received from the first UE in a discovery message. Alternatively or additionally, when the second UE is linked to the first UE, the first frequency information may be transmitted by the first UE proactively or in response to a request from the second UE.

In accordance with an exemplary embodiment, the first frequency information as described according to the fifth aspect of the present disclosure may correspond to the first frequency information as described according to the first aspect of the present disclosure. Thus, the first frequency information as described according to the first and fifth aspects of the present disclosure may have the same or similar contents and/or feature elements.

In accordance with an exemplary embodiment, the second UE may operate as a relay UE for the first UE, and the first UE may operate as a remote UE.

In accordance with an exemplary embodiment, the method according to the fifth aspect of the present disclosure may further comprise transmitting, to the first UE, one or more of:
second frequency information indicating one or more frequencies of the second UE;
an indication of whether the one or more frequencies of the first UE are overlapped with the one or more frequencies of the second UE;
an indication of whether the second UE is able to monitor paging for the first UE; and
an indication of one or more frequencies in which the second UE is able to monitor the paging for the first UE.

In accordance with an exemplary embodiment, the second frequency information as described according to the fifth aspect of the present disclosure may correspond to the second frequency information as described according to the first aspect of the present disclosure. Thus, the second frequency information as described according to the first and fifth aspects of the present disclosure may have the same or similar contents and/or feature elements.

In accordance with an exemplary embodiment, when one or more Uu frequencies which the first UE camps on are not overlapped with one or more Uu frequencies which the second UE operates on, the method according to the fifth aspect of the present disclosure may further comprise: selecting to monitor paging for the first UE in the one or more Uu frequencies which the first UE camps on, when the one or more Uu frequencies which the first UE camps on are supported for paging by the second UE.

In accordance with an exemplary embodiment, the method according to the fifth aspect of the present disclosure may further comprise: transmitting an identifier of the first UE to a base station.

In accordance with an exemplary embodiment, the method according to the fifth aspect of the present disclosure may further comprise: selecting to monitor paging for the first UE in one or more Uu frequencies which the second UE operates on and/or are supported for paging by the second UE.

In accordance with an exemplary embodiment, when the second UE is not able to monitor paging for the first UE, the method according to the fifth aspect of the present disclosure may further comprise: receiving event information from the first UE. In an embodiment, the event information may indicate that no other relay UE being able to monitor the paging for the first UE is selected by using a relay reselection procedure of the first UE, and/or that no cell is selected for the first UE by using a cell reselection procedure of the first UE.

In accordance with an exemplary embodiment, the method according to the fifth aspect of the present disclosure may further comprise: starting to monitor the paging for the first UE, when the second UE becomes to be capable of monitoring the paging for the first UE.

In accordance with an exemplary embodiment, the second UE may operate as a remote UE, and the first UE may operate as a relay UE for the second UE.

In accordance with an exemplary embodiment, the method according to the fifth aspect of the present disclosure may further comprise transmitting, to the first UE, one or more of:
second frequency information indicating one or more frequencies of the second UE; and
an indication of whether the one or more frequencies of the first UE are overlapped with the one or more frequencies of the second UE.

In accordance with an exemplary embodiment, the method according to the fifth aspect of the present disclosure may further comprise: deprioritizing the first UE in relay selection or reselection by the second UE, when the one or more frequencies of the first UE are not overlapped with one or more frequencies of the second UE.

In accordance with an exemplary embodiment, the method according to the fifth aspect of the present disclosure may further comprise: triggering a relay reselection procedure to select another relay UE for the second UE and/or a cell reselection procedure to select a cell for the second UE, when the first UE is not able to monitor the paging for the second UE.

In accordance with an exemplary embodiment, the method according to the fifth aspect of the present disclosure may further comprise: transmitting event information to the first UE. In an embodiment, the event information may indicate that no other relay UE being able to monitor the paging for the second UE is selected by using the relay reselection procedure, and/or that no cell is selected for the second UE by using the cell reselection procedure.

In accordance with an exemplary embodiment, the method according to the fifth aspect of the present disclosure may further comprise: entering an RRC connected state from an RRC idle/inactive state, when an event persists for a predetermined period. In an embodiment, the event may include that no other relay UE being able to monitor the paging for the second UE is selected by using the relay reselection procedure, and/or that no cell is selected for the second UE by using the cell reselection procedure.

In accordance with an exemplary embodiment, the method according to the fifth aspect of the present disclosure may further comprise transmitting, to a base station, information about one or more of:
whether the second UE is able to find a relay UE which is able to monitor paging for the second UE and has PC5 link quality higher than a third threshold;
whether the second UE is able to find a cell which has Uu link quality higher than a fourth threshold; and
whether one or more relay UEs included in a measurement report of the second UE are able to monitor the paging for the second UE.

In accordance with an exemplary embodiment, the method according to the fifth aspect of the present disclosure may further comprise: receiving, from a base station, information about a third list of relay UEs and/or a fourth list of relay UEs. In an embodiment, the third list of relay UEs may include one or more relay UEs available for the second UE in an RRC idle/inactive state, and the fourth list of relay UEs may include one or more relay UEs not available for the second UE in an RRC idle/inactive state.

According to a sixth aspect of the present disclosure, there is provided an apparatus which may be implemented as a second UE. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a second UE. The apparatus may comprise a receiving unit and a determining unit. In accordance with some exemplary embodiments, the receiving unit may be operable to carry out at least the receiving step of the method according to the fifth aspect of the present disclosure. The determining unit may be operable to carry out at least the determining step of the method according to the fifth aspect of the present disclosure.

According to a ninth aspect of the present disclosure, there is provided a method performed by a base station. The method comprises: transmitting a paging message for a remote UE via a relay UE. In an embodiment, frequency information of the remote UE and/or frequency information of the relay UE may be exchanged between the remote UE and the relay UE.

In accordance with an exemplary embodiment, the remote UE as described according to the ninth aspect of the present disclosure may correspond to the first UE as described according to the first aspect of the present disclosure, and the relay UE as described according to the ninth aspect of the present disclosure may correspond to the second UE as described according to the fifth aspect of the present disclosure.

In accordance with another exemplary embodiment, the remote UE as described according to the ninth aspect of the present disclosure may correspond to the second UE as described according to the fifth aspect of the present disclosure, and the relay UE as described according to the ninth aspect of the present disclosure may correspond to the first UE as described according to the first aspect of the present disclosure.

In accordance with an exemplary embodiment, the frequency information of the remote UE may indicate: one or more Uu frequencies which the remote UE camps on when the remote UE is in an RRC idle/inactive state; and/or one or more Uu frequency bands which the remote UE is able to support for paging.

In accordance with an exemplary embodiment, the frequency information of the relay UE may indicate: one or more Uu frequencies which the relay UE operates on; and/or one or more Uu frequency bands which the relay UE is able to support for paging.

In accordance with an exemplary embodiment, the paging message may be transmitted in one or more Uu frequencies which the remote UE camps on and are supported for paging by the relay UE.

In accordance with an exemplary embodiment, the method according to the ninth aspect of the present disclosure may further comprise: receiving an identifier of the remote UE from the relay UE.

In accordance with an exemplary embodiment, the paging message may be transmitted in one or more Uu frequencies which the relay UE operates on and/or are supported for paging by the relay UE.

In accordance with an exemplary embodiment, the method according to the ninth aspect of the present disclosure may further comprise: informing another base station and/or a core network node of an association between the identifier of the remote UE and one or more Uu frequencies in which the remote UE is to be paged.

In accordance with an exemplary embodiment, the method according to the ninth aspect of the present disclosure may further comprise: transmitting, to the remote UE, information about a fifth list of relay UEs and/or a sixth list of relay UEs. In an embodiment, the fifth list of relay UEs may include one or more relay UEs available for the remote UE in an RRC idle/inactive state, and the sixth list of relay UEs may include one or more relay UEs not available for the remote UE in an RRC idle/inactive state.

In accordance with an exemplary embodiment, the fifth list of relay UEs and/or the sixth list of relay UEs may be determined by the base station based at least in part on frequency information provided by: the remote UE; one or more relay UEs for the remote UE; one or more other base stations; and/or one or more core network nodes.

In accordance with an exemplary embodiment, the method according to the ninth aspect of the present disclosure may further comprise receiving, from the remote UE, information about one or more of:
whether the remote UE is able to find a relay UE which is able to monitor paging for the remote UE and has PC5 link quality higher than a fifth threshold;
whether the remote UE is able to find a cell which has Uu link quality higher than a sixth threshold; and
whether one or more relay UEs included in a measurement report of the remote UE are able to monitor the paging for the remote UE.

In accordance with an exemplary embodiment, the method according to the ninth aspect of the present disclosure may further comprise: determining whether the base station is able to reach the remote UE in an RRC idle/inactive state, according to the information received from the remote UE.

In accordance with an exemplary embodiment, the method according to the ninth aspect of the present disclosure may further comprise: keeping the remote UE in an RRC connected state, when determining that the base station is not able to reach the remote UE in the RRC idle/inactive state.

According to a tenth aspect of the present disclosure, there is provided an apparatus which may be implemented as a base station. The apparatus may comprise one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a base station. The apparatus may comprise a transmitting unit and optionally a receiving unit. In accordance with some exemplary embodiments, the transmitting unit may be operable to carry out at least the transmitting step of the method according to the ninth aspect of the present disclosure. The receiving unit may be operable to carry out at least the receiving step of the method according to the ninth aspect of the present disclosure.

According to a thirteenth aspect of the present disclosure, there is provided a method performed by a third UE. The method comprises: receiving configuration information from a base station. The configuration information may indicate one or more predetermined frequencies in which a fourth UE is to be paged via the third UE.

In accordance with an exemplary embodiment, the method according to the thirteenth aspect of the present disclosure may further comprise: receiving, from the fourth UE, a first indication of whether the fourth UE performs a reselection from a relay UE to a cell or from a cell to a relay UE.

In accordance with an exemplary embodiment, the method according to the thirteenth aspect of the present disclosure may further comprise: forwarding the first indication from the fourth UE to the base station.

In accordance with an exemplary embodiment, the method according to the thirteenth aspect of the present disclosure may further comprise: monitoring paging for the fourth UE in the one or more predetermined frequencies, when the third UE operates as a relay UE for the fourth UE and is able to monitor the paging in the one or more predetermined frequencies.

In accordance with an exemplary embodiment, the method according to the thirteenth aspect of the present disclosure may further comprise: transmitting, to the fourth UE, a second indication of whether the third UE is able to monitor paging for the fourth UE in the one or more predetermined frequencies, and/or a third indication of one or more frequencies in which the third UE is able to monitor the paging for the fourth UE.

In accordance with an exemplary embodiment, when the third UE is not able to monitor paging for the fourth UE in the one or more predetermined frequencies, the method according to the thirteenth aspect of the present disclosure may further comprise: receiving event information from the fourth UE. In an embodiment, the event information may indicate that no other relay UE being able to monitor the paging for the fourth UE is selected by using a relay reselection procedure of the fourth UE, and/or that no cell is selected for the fourth UE by using a cell reselection procedure of the fourth UE.

In accordance with an exemplary embodiment, the method according to the thirteenth aspect of the present disclosure may further comprise: starting to monitor the paging for the fourth UE in the one or more predetermined frequencies, when the third UE becomes to be capable of monitoring the paging in the one or more predetermined frequencies.

In accordance with an exemplary embodiment, the third UE may communicate with the fourth UE by using one or more of:
RRC signaling;
PC5-S signaling;
discovery signaling;
a MAC CE;
a PDU of a protocol layer; and
L1 signaling on sidelink channels.

In accordance with an exemplary embodiment, the third UE and/or the fourth UE may communicate with the base station by using one or more of:
RRC signaling;
a MAC CE;
a paging message;
a PDU of a protocol layer; and
L1 signaling.

According to a fourteenth aspect of the present disclosure, there is provided an apparatus which may be implemented as a third UE. The apparatus may comprise one or more processors and one or more memories storing computer program codes. The one or more memories and the computer program codes may be configured to, with the one or more processors, cause the apparatus at least to perform any step of the method according to the thirteenth aspect of the present disclosure.

According to a fifteenth aspect of the present disclosure, there is provided a computer-readable medium having computer program codes embodied thereon which, when executed on a computer, cause the computer to perform any step of the method according to the thirteenth aspect of the present disclosure.

According to a sixteenth aspect of the present disclosure, there is provided an apparatus which may be implemented as a third UE. The apparatus may comprise a receiving unit and optionally a monitoring unit. In accordance with some exemplary embodiments, the receiving unit may be operable to carry out at least the receiving step of the method according to the thirteenth aspect of the present disclosure. The monitoring unit may be operable to carry out at least the monitoring step of the method according to the thirteenth aspect of the present disclosure.

According to a seventeenth aspect of the present disclosure, there is provided a method performed by a fourth UE. The method comprises: receiving configuration information from a base station. The configuration information may indicate one or more predetermined frequencies in which the fourth UE is to be paged via a third UE.

In accordance with an exemplary embodiment, the configuration information as described according to the seventeenth aspect of the present disclosure may correspond to the configuration information as described according to the thirteenth aspect of the present disclosure. Thus, the configuration information according to the thirteenth and seventeenth aspects of the present disclosure may have the same or similar contents and/or feature elements.

In accordance with an exemplary embodiment, the method according to the seventeenth aspect of the present disclosure may further comprise: transmitting, to the base station, a first indication of whether the fourth UE performs a reselection from a relay UE to a cell or from a cell to a relay UE.

In accordance with an exemplary embodiment, the method according to the seventeenth aspect of the present disclosure may further comprise: monitoring paging for the fourth UE in one or more Uu frequencies which the fourth UE camps on and/or supports for paging, when the fourth UE performs a reselection from a relay UE to a cell.

In accordance with an exemplary embodiment, the method according to the seventeenth aspect of the present disclosure may further comprise: receiving, from the third UE, a second indication of whether the third UE is able to monitor paging for the fourth UE in the one or more predetermined frequencies, and/or a third indication of one or more frequencies in which the third UE is able to monitor the paging for the fourth UE.

In accordance with an exemplary embodiment, the method according to the seventeenth aspect of the present disclosure may further comprise: deprioritizing the third UE in relay selection or reselection by the fourth UE, when the third UE is not able to monitor the paging for the fourth UE in the one or more predetermined frequencies.

In accordance with an exemplary embodiment, the method according to the seventeenth aspect of the present disclosure may further comprise: triggering a relay reselection procedure to select another relay UE for the fourth UE and/or a cell reselection procedure to select a cell for the fourth UE, when the third UE is not able to monitor the paging for the fourth UE in the one or more predetermined frequencies.

In accordance with an exemplary embodiment, the method according to the seventeenth aspect of the present disclosure may further comprise: transmitting event information to the third UE. In an embodiment, the event information may indicate that no other relay UE being able to monitor the paging for the fourth UE is selected by using the relay reselection procedure, and/or that no cell is selected for the fourth UE by using the cell reselection procedure.

In accordance with an exemplary embodiment, the method according to the seventeenth aspect of the present disclosure may further comprise: entering an RRC connected state from an RRC idle/inactive state, when an event persists for a predetermined period. In an embodiment, the event may include that no other relay UE being able to monitor the paging for the fourth UE is selected by using the relay reselection procedure, and/or that no cell is selected for the fourth UE by using the cell reselection procedure.

In accordance with an exemplary embodiment, the method according to the seventeenth aspect of the present disclosure may further comprise transmitting, to the base station, information about one or more of:
whether the fourth UE is able to find a relay UE which is able to monitor paging for the fourth UE and has PC5 link quality higher than a seventh threshold;
whether the fourth UE is able to find a cell which has Uu link quality higher than an eighth threshold; and
whether one or more relay UEs included in a measurement report of the fourth UE are able to monitor the paging for the fourth UE.

In accordance with an exemplary embodiment, the method according to the seventeenth aspect of the present disclosure may further comprise: receiving, from the base station, information about a seventh list of relay UEs and/or an eighth list of relay UEs. In an embodiment, the seventh list of relay UEs may include one or more relay UEs available for the fourth UE in an RRC idle/inactive state, and the eighth list of relay UEs may include one or more relay UEs not available for the fourth UE in an RRC idle/inactive state.

According to an eighteenth aspect of the present disclosure, there is provided an apparatus which may be implemented as a fourth UE. The apparatus may comprise one or more processors and one or more memories storing computer program codes. The one or more memories and the computer program codes may be configured to, with the one or more processors, cause the apparatus at least to perform any step of the method according to the seventeenth aspect of the present disclosure.

According to a nineteenth aspect of the present disclosure, there is provided a computer-readable medium having computer program codes embodied thereon which, when executed on a computer, cause the computer to perform any step of the method according to the seventeenth aspect of the present disclosure.

According to a twentieth aspect of the present disclosure, there is provided an apparatus which may be implemented as a fourth UE. The apparatus may comprise a receiving unit and optionally a transmitting unit. In accordance with some exemplary embodiments, the receiving unit may be operable to carry out at least the receiving step of the method according to the seventeenth aspect of the present disclosure. The transmitting unit may be operable to carry out at least the transmitting step of the method according to the seventeenth aspect of the present disclosure.

According to a twenty-first aspect of the present disclosure, there is provided a method performed by a base station. The method comprises: determining configuration information. The configuration information may indicate one or more predetermined frequencies in which a fourth UE is to be paged via a third UE. In accordance with an exemplary embodiment, the method further comprises: transmitting the configuration information to the third UE.

In accordance with an exemplary embodiment, the configuration information transmitted by the base station according to the twenty-first aspect of the present disclosure may correspond to the configuration information received by the third UE according to the thirteenth aspect of the present disclosure and the configuration information received by the fourth UE according to the seventeenth aspect of the present disclosure. Thus, the configuration information according to the thirteenth, seventeenth and twenty-first aspects of the present disclosure may have the same or similar contents and/or feature elements.

In accordance with an exemplary embodiment, the method according to the twenty-first aspect of the present disclosure may further comprise: receiving, from the fourth UE, a first indication of whether the fourth UE performs a reselection from a relay UE to a cell or from a cell to a relay UE.

In accordance with an exemplary embodiment, the method according to the twenty-first aspect of the present disclosure may further comprise: transmitting a paging message for the fourth UE in the one or more predetermined frequencies, when the third UE operates as a relay UE for the fourth UE and is able to monitor paging in the one or more predetermined frequencies.

In accordance with an exemplary embodiment, the method according to the twenty-first aspect of the present disclosure may further comprise: transmitting a paging message for the fourth UE in one or more Uu frequencies which the fourth UE camps on and/or supports for paging, when the fourth UE performs a reselection from the relay UE to the cell.

In accordance with an exemplary embodiment, the method according to the twenty-first aspect of the present disclosure may further comprise: transmitting the configuration information to the fourth UE.

In accordance with an exemplary embodiment, the method according to the twenty-first aspect of the present disclosure may further comprise: transmitting, to the fourth UE, information about a ninth list of relay UEs and/or a tenth list of relay UEs. In an embodiment, the ninth list of relay UEs may include one or more relay UEs available for the fourth UE in an RRC idle/inactive state, and the tenth list of relay UEs may include one or more relay UEs not available for the fourth UE in an RRC idle/inactive state.

In accordance with an exemplary embodiment, the ninth list of relay UEs and/or the tenth list of relay UEs may be determined by the base station based at least in part on frequency information provided by: the fourth UE; one or more relay UEs for the fourth UE; one or more other base stations; and/or one or more core network nodes.

In accordance with an exemplary embodiment, the method according to the twenty-first aspect of the present disclosure may further comprise receiving, from the fourth UE, information about one or more of:
whether the fourth UE is able to find a relay UE which is able to monitor paging for the fourth UE and has PC5 link quality higher than a ninth threshold;
whether the fourth UE is able to find a cell which has Uu link quality higher than a tenth threshold; and
whether one or more relay UEs included in a measurement report of the fourth UE are able to monitor the paging for the fourth UE.

In accordance with an exemplary embodiment, the method according to the twenty-first aspect of the present disclosure may further comprise: determining whether the base station is able to reach the fourth UE in an RRC idle/inactive state, according to the information received from the fourth UE.

In accordance with an exemplary embodiment, the method according to the twenty-first aspect of the present disclosure may further comprise: keeping the fourth UE in an RRC connected state, when determining that the base station is not able to reach the fourth UE in the RRC idle/inactive state.

According to a twenty-second aspect of the present disclosure, there is provided an apparatus which may be implemented as a base station. The apparatus may comprise one or more processors and one or more memories storing computer program codes. The one or more memories and the computer program codes may be configured to, with the one or more processors, cause the apparatus at least to perform any step of the method according to the twenty-first aspect of the present disclosure.

According to a twenty-third aspect of the present disclosure, there is provided a computer-readable medium having computer program codes embodied thereon which, when executed on a computer, cause the computer to perform any step of the method according to the twenty-first aspect of the present disclosure.

According to a twenty-fourth aspect of the present disclosure, there is provided an apparatus which may be implemented as a base station. The apparatus may comprise a determining unit and a transmitting unit. In accordance with some exemplary embodiments, the determining unit may be operable to carry out at least the determining step of the method according to the twenty-first aspect of the present disclosure. The transmitting unit may be operable to carry out at least the transmitting step of the method according to the twenty-first aspect of the present disclosure.

According to a twenty-fifth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the ninth or twenty-first aspect of the present disclosure.

According to a twenty-sixth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the ninth or twenty-first aspect of the present disclosure.

According to a twenty-seventh aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first, fifth, thirteenth or seventeenth aspect of the present disclosure.

According to a twenty-eighth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first, fifth, thirteenth or seventeenth aspect of the present disclosure.

According to a twenty-ninth aspect of the present disclosure, there is provided a method implemented in a communication system which may include a host computer, a base station and a UE. The method may comprise, at the host computer, receiving user data transmitted to the base station from the UE which may perform any step of the method according to the first, fifth, thirteenth or seventeenth aspect of the present disclosure.

According to a thirtieth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first, fifth, thirteenth or seventeenth aspect of the present disclosure.

According to a thirty-first aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the ninth or twenty-first aspect of the present disclosure.

According to a thirty-second aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the ninth or twenty-first aspect of the present disclosure.

According to various exemplary embodiments, a remote UE may be reached with a relay UE monitoring paging for the remote UE, even when different Uu frequencies are used or supported by the remote UE and the relay UE. This can improve network performance, transmission efficiency and user experience.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1A is a diagram illustrating an exemplary user plane stack for Layer-2 (L2) UE-to-Network relay UE according to an embodiment of the present disclosure;

FIG. 1B is a diagram illustrating an exemplary control plane stack for L2 UE-to-Network relay UE according to an embodiment of the present disclosure;

FIG. 2 is a diagram illustrating exemplary paging for evolved ProSe remote UE according to an embodiment of the present disclosure;

FIGS. 3A-3C are diagrams illustrating exemplary random access (RA) based and configured grant (CG) based small data transmission according to some embodiments of the present disclosure;

FIGS. 4A-4F are flowcharts illustrating various methods according to some embodiments of the present disclosure;

FIG. 5 is a block diagram illustrating an apparatus according to some embodiments of the present disclosure;

FIGS. 6A-6F are block diagrams illustrating various apparatuses according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. To meet dramatically increasing network requirements on traffic capacity and data rates, one interesting option for communication technique development is to allow D2D communications to be implemented in a wireless communication network such as 4G/LTE or 5G/NR network. As used herein, D2D may be referred to in a broader sense to include communications between any types of UEs, and include V2X communications between a vehicle UE and any other type of UE. D2D and/or V2X may be a component of many existing wireless technologies when it comes to direct communication between wireless devices. D2D and/or V2X communications as an underlay to cellular networks may be proposed as an approach to take advantage of the proximity of devices.

Sidelink transmissions over NR are specified by 3GPP for Release 16. These are some enhancements of the ProSe specified for LTE. As an example, four new enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of physical sidelink common control channel (PSCCH).
To achieve a high connection density, congestion control and thus the quality of service (QOS) management is supported in NR sidelink transmissions.

In order to enable the above enhancements, some new physical channels and reference signals may be introduced in NR (some are available in LTE before) as follows:
Physical Sidelink Shared Channel (PSSCH, SL version of PDSCH): The PSSCH may be transmitted by a sidelink transmitter UE, which may convey sidelink transmission data, system information blocks (SIBs) for radio resource control (RRC) configuration, and a part of the sidelink control information (SCI).
Physical Sidelink Feedback Channel (PSFCH, SL version of physical uplink control channel (PUCCH)): The PSFCH may be transmitted by a sidelink receiver UE for unicast and groupcast, which may convey 1-bit information over 1 resource block for the hybrid automatic repeat request (HARQ) acknowledgement (ACK) and the negative ACK (NACK). In addition, channel state information (CSI) may be carried in the medium access control (MAC) control element (CE) over the PSSCH instead of the PSFCH.
Physical Sidelink Common Control Channel (PSCCH, SL version of physical downlink control channel (PDCCH)): When the traffic to be sent to a receiver UE arrives at a transmitter UE, a transmitter UE may first send the PSCCH, which may convey a part of sidelink control information (SCI, SL version of downlink control information (DCI)) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) may be supported. Through detecting the S-PSS and S-SSS, a UE may be able to identify the sidelink synchronization identity (SSID) from the UE sending the S-PSS/S-SSS. Through detecting the S-PSS/S-SSS, a UE may be therefore able to know the characteristics of the UE transmitting the S-PSS/S-SSS. A series of processes of acquiring timing and frequency synchronization together with SSIDs of UEs may be called initial cell search. It can be appreciated that the UE sending the S-PSS/S-SSS may not be necessarily involved in sidelink transmissions, and a node (e.g., a UE/eNB/gNB) sending the S-PSS/S-SSS may be called a synchronization source. There may be 2 S-PSS sequences and 336 S-SSS sequences forming a total of 672 SSIDs in a cell.
Physical Sidelink Broadcast Channel (PSBCH): The PSBCH may be transmitted along with the S-PSS/S-SSS as a synchronization signal/PSBCH block (SSB). The SSB may have the same numerology as PSCCH/PSSCH on that carrier, and an SSB may be transmitted within the bandwidth of the configured bandwidth part (BWP). The PSBCH may convey information related to synchronization, such as the direct frame number (DFN), an indication of the slot and symbol level time resources for sidelink transmissions, an in-coverage indicator, etc. The SSB may be transmitted periodically at every 160 ms.
DMRS, phase tracking-reference signal (PT-RS), channel state information reference signal (CSIRS): These physical reference signals supported by NR downlink/uplink transmissions may also be adopted by sidelink transmissions. Similarly, the PT-RS may be only applicable for frequency range 2 (FR2) transmission.

Another new feature is the two-stage SCI, which is a version of the DCI for SL. Unlike the DCI, only part (first stage) of the SCI may be sent on the PSCCH. This part may be used for channel sensing purposes (including the reserved time-frequency resources for transmissions, DMRS pattern and antenna port, etc.) and can be read by all UEs while the remaining (second stage) scheduling and control information such as a 8-bits source identity (ID) and a 16-bits destination ID, new data indicator (NDI), redundancy version (RV) and HARQ process ID may be sent on the PSSCH to be decoded by the receiver UE.

Similar as for ProSe in LTE, NR sidelink transmissions may have the following two modes of resource allocations:
Mode 1: Sidelink resources are scheduled by a gNB.
Mode 2: The UE autonomously selects sidelink resources from a (pre-) configured sidelink resource pool(s) based on the channel sensing mechanism.

For the in-coverage UE, a gNB may be configured to adopt Mode 1 or Mode 2. For the out-of-coverage UE, only Mode 2 may be adopted.

As in LTE, scheduling over the sidelink in NR may be done in different ways for Mode 1 and Mode 2. In accordance with an exemplary embodiment, Mode 1 may support the following two kinds of grants:
Dynamic grant: When the traffic to be sent over sidelink arrives at a transmitter UE, this UE may launch the four-message exchange procedure to request sidelink resources from a gNB (e.g., a scheduling request (SR) on UL, a grant, a buffer status report (BSR) on UL, a grant for data on SL sent to UE). During the resource request procedure, the gNB may allocate a sidelink radio network temporary identifier (SL-RNTI) to the transmitter UE. If this sidelink resource request is granted by the gNB, then the gNB may indicate the resource allocation for the PSCCH and the PSSCH in the DCI conveyed by PDCCH with cyclic redundancy check (CRC) scrambled with the SL-RNTI. When the transmitter UE receives such DCI, the transmitter UE can obtain the grant only if the scrambled CRC of DCI can be successfully solved by the assigned SL-RNTI. The transmitter UE then may indicate the time-frequency resources and the transmission scheme of the allocated PSSCH in the PSCCH, and launch the PSCCH and the PSSCH on the allocated resources for sidelink transmissions. When a grant is obtained from the gNB, the transmitter UE can only transmit a single transport block (TB). As a result, this kind of grant may be suitable for traffic with a loose latency requirement.

Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources may be reserved in a periodic manner. Upon traffic arriving at the transmitter UE, this UE may launch the PSCCH and the PSSCH on the upcoming resource occasion. In fact, this kind of grant is also known as grant-free transmissions.

In both dynamic grant and configured grant, a sidelink receiver UE may not receive the DCI (since it is addressed to the transmitter UE), and therefore the receiver UE may perform blind decoding to identify the presence of PSCCH and find the resources for the PSSCH through the SCI.

In an embodiment, when the transmitter UE launches the PSCCH, CRC may also be inserted in the SCI without any scrambling.

In the Mode 2 resource allocation, when traffic arrives at a transmitter UE, this transmitter UE may autonomously select resources for the PSCCH and the PSSCH. To further minimize the latency of the feedback HARQ ACK/NACK transmissions and subsequently retransmissions, the transmitter UE may also reserve resources for PSCCH/PSSCH for retransmissions. To further enhance the probability of successful TB decoding at one shot and thus suppress the probability to perform retransmissions, the transmitter UE may repeat the TB transmission along with the initial TB transmission. This mechanism is also known as blind retransmission. As a result, when traffic arrives at the transmitter UE, then this transmitter UE may select resources for the following transmissions:
1) The PSSCH associated with the PSCCH for initial transmission and blind retransmissions.
2) The PSSCH associated with the PSCCH for retransmissions.

Since each transmitter UE in sidelink transmissions may autonomously select resources for above transmissions, how to prevent different transmitter UEs from selecting the same resources turns out to be a critical issue in Mode 2. A particular resource selection procedure may be therefore imposed to Mode 2 based on channel sensing. In an embodiment, a channel sensing algorithm may involve measuring reference signal received power (RSRP) on different sub-channels and require knowledge of the different UEs power levels of DMRS on the PSSCH or the DMRS on the PSCCH depending on the configuration. This kind of information may be known only after receiving SCI launched by (all) other UEs. The sensing and selection algorithm may be rather complex.

The concept of Layer-2 based UE-to-Network (U2N) relay is described in clause 6.7 of 3GPP technical report (TR) 23.752 V2.0.0. In accordance with an exemplary embodiment, a L2 UE-to-Network relay UE may provide forwarding functionality that can relay any type of traffic over the PC5 link. For example, the L2 UE-to-Network relay UE may provide the functionality to support connectivity to the 5G system (5GS) for remote UEs. A UE may be considered to be a remote UE if it has successfully established a PC5 link to the L2 UE-to-Network relay UE. The remote UE may be located within next generation-radio access network (NG-RAN) coverage or outside of NG-RAN coverage.

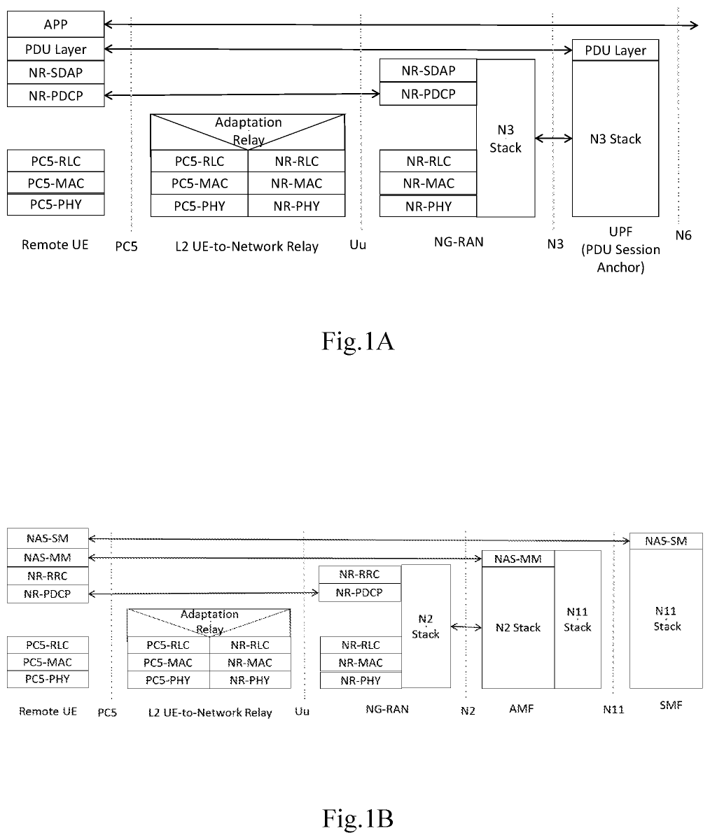

FIG. 1A is a diagram illustrating an exemplary user plane stack for L2 UE-to-Network relay UE according to an embodiment of the present disclosure. The protocol stack for the user plane transport may be related to a protocol data unit (PDU) session, including a L2 UE-to-Network relay UE. The PDU layer corresponds to the PDU carried between the remote UE and the data network (DN) over the PDU session. The two endpoints of the PDCP link are the remote UE and a gNB in the network. The relay function may be performed below the PDCP layer. This means that data security may be ensured between the remote UE and the gNB without exposing raw data at the UE-to-Network relay UE.

The adaptation relay layer within the UE-to-Network relay UE can differentiate between signaling radio bearers (SRBs) and data radio bearers (DRBs) for a particular remote UE. The adaption relay layer may also be responsible for mapping PC5 traffic to one or more DRBs of the Uu interface.

FIG. 1B is a diagram illustrating an exemplary control plane stack for L2 UE-to-Network relay UE according to an embodiment of the present disclosure. The role of the UE-to-Network Relay UE may be to relay the PDUs from the signaling radio bearer without any modifications. The protocol stack as shown in FIG. 1B may be applicable to the non-access stratum (NAS) connection for the remote UE to the non-access stratum-mobility management (NAS-MM) and non-access stratum-session management (NAS-SM) components. The NAS messages may be transparently transferred between the remote UE and 5G access network (5G-AN) over the L2 UE-to-Network relay UE using:
PDCP end-to-end connection where the role of the UE-to-Network relay UE is to relay the PDUs over the signalling radio bear without any modifications.
N2 connection between the 5G-AN and access and mobility management function (AMF) over N2.
N3 connection AMF and SMF over N11.

When a remote UE is in RRC_IDLE or RRC_INACTIVE state and there is incoming downlink (DL) traffic for the remote UE, the NW may page the remote UE, and a L2 UE-to-Network relay UE may support forwarding of paging for the remote UE. In LTE, multiple possible paging options with which the remote UE in RRC_IDLE can be reachable are investigated 3GPP TR 36.746 V15.1.1, and it is agreed in RAN2 that the paging Option 2 is selected as the baseline paging relaying solution for NR L2 UE-to-NW relay. The contents of paging Option 2 studied in 3GPP TR 36.746 V15.1.1 is described as below.

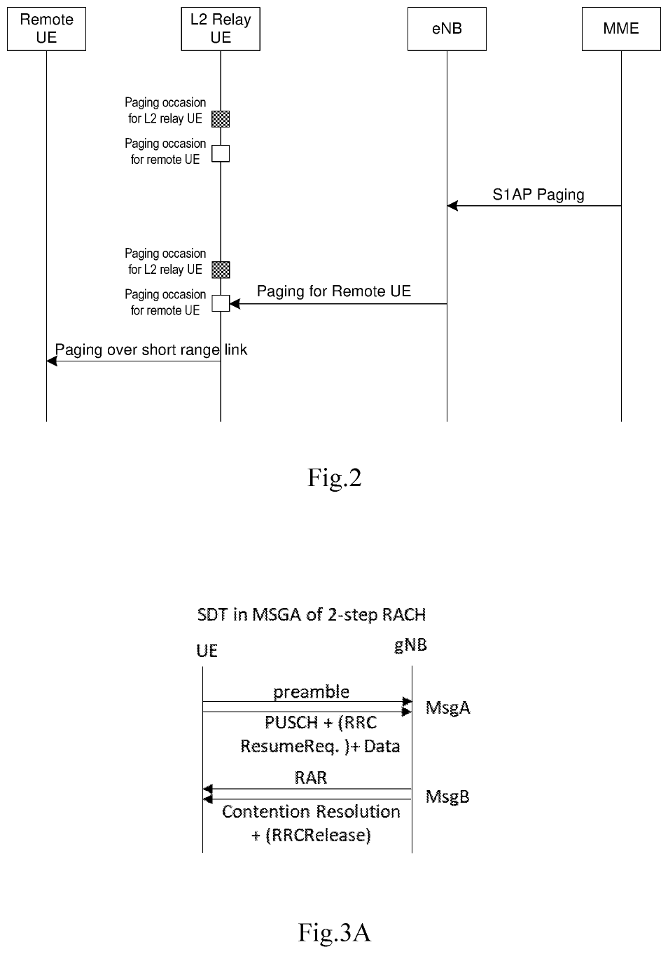

FIG. 2 is a diagram illustrating exemplary paging for evolved ProSe remote UE according to an embodiment of the present disclosure. For simplicity, FIG. 2 only depicts exemplary devices or functions, e.g., a remote UE, a L2 UE-to-Network relay UE, an eNB and a mobility management entity (MME). According to paging Option 2 for a remote UE with L2 UE-to-NW relay, the evolved L2 ProSe UE-to-Network relay UE may monitor its linked evolved ProSe remote UE's paging occasion (PO) in addition to its own PO. The evolved ProSe remote UE may not need to attempt paging reception over downlink while linked to the evolved L2 ProSe UE-to-Network relay UE. The evolved L2 ProSe UE-to-Network relay UE may need to monitor multiple POs. The evolved L2 ProSe UE-to-Network relay UE may need to know the PO of the evolved ProSe remote UE and to decode a paging message and determine which evolved ProSe remote UE the paging is for. Also, the evolved L2 ProSe UE-to-Network relay UE may need to relay the evolved ProSe remote UE's paging over a short-range link, as shown in FIG. 2.

Many advantages may be achieved by applying paging Option 2, e.g., including but not limited to:
It is commonly applicable to both when the evolved ProSe remote UE is in and out of evolved-universal telecommunication radio access network E-UTRAN coverage;
The evolved ProSe remote UE may not need to attempt paging reception over DL while linked to the evolved ProSe UE-to-Network relay UE. This is more power efficient for the evolved ProSe remote UE; and
There is no need for a network to know whether the evolved ProSe remote UE and the evolved ProSe UE-to-Network relay UE are linked or associated.

On the other hand, there may be some disadvantages as below when applying paging Option 2:
The evolved ProSe UE-to-Network relay UE may need to monitor multiple POs. This is less power efficient for the evolved ProSe UE-to-Network relay UE as the power consumption may increase depending on the number of evolved ProSe remote UEs linked to the evolved ProSe UE-to-Network relay UE; and
The evolved ProSe UE-to-Network relay UE may need to relay the evolved ProSe remote UE's paging over a short-range link. This causes additional power consumption for the evolved ProSe UE-to-Network relay UE and additional use of sidelink resource.

The UE-to-Network relay discovery may be applicable to both Layer-3 and Layer-2 UE-to-Network relay discovery for both public safety services and commercial services. A remote UE and a UE-to-Network relay UE may use pre-configured or provisioned information for the relay discovery procedures.

Additional information used for the UE-to-Network relay (re) selection and connection maintenance can be advertised using a separate discovery messages of type “Relay Discovery Additional Information”. This may include for example the related system information of the UE-to-Network relay's serving cell.

In accordance with some exemplary embodiments, both Model A and Model B discovery may be supported:
Model A uses a single discovery protocol message (Announcement), which can only be sent by the UE-to-Network relay UE.
Model B uses two discovery protocol messages (Solicitation and Response), which can only be initiated by the remote UE.

For “Relay Discovery Additional Information”, only Model A discovery may be used.

In accordance with an exemplary embodiment, the mapping of ProSe services (i.e. Application IDs) to Destination Layer-2 ID(s) for sending/receiving initial signaling of discovery messages may be provisioned to the UE by e.g. a core NW, while the UE may self-select a Source Layer-2 ID for ProSe Discovery.

In 3GPP Release 16, small data transmission (SDT) is introduced for control plane (CP) signaling transmission in RRC INACTIVE mode. In 3GPP Release 17, this is further extended to user plane (UP) data transmission.

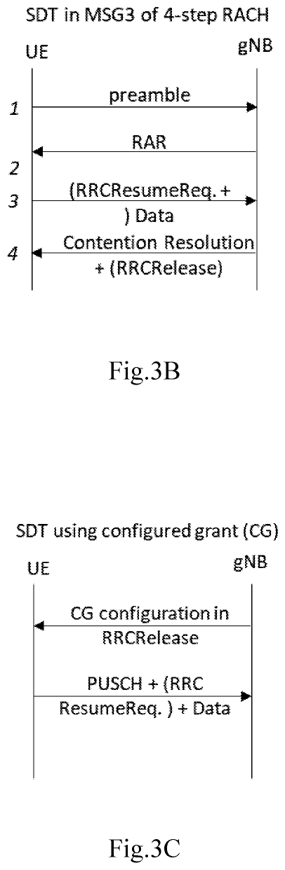

FIGS. 3A-3C are diagrams illustrating exemplary RA based and CG based SDT according to some embodiments of the present disclosure. For an RA based scheme as shown in FIG. 3A, a UE may transmit some data and an RRCResume request in Message A (MsgA) including a preamble and physical uplink shared channel (PUSCH) data from a UE to a gNB in a 2-step RA procedure (2-step RACH). An RRCRelease message may be sent in a separate message later than Message B (MsgB) including a random access response (RAR) and contention resolution. For another RA based scheme as shown in FIG. 3B, a UE may transmit some data and an RRCResume request in Message 3 (Msg3) from a UE to a gNB in a 4-step RA procedure (4-step RACH). An RRCRelease message may be sent in a separate message later than Message 4 (Msg4) including contention resolution. In an embodiment, an UL/DL transmission may be performed by the UE in RRC INACTIVE state before receiving an RRC release message (not shown in figures). For a CG based scheme as shown in FIG. 3C, a UE may receive CG configuration in an RRCRelease message from a gNB, and transmit some data and an RRCResume request together with PUSCH data to the gNB.

In some cases, a remote UE and a relay UE may be paged on different Uu frequencies due to e.g. the remote UE and the relay UE are camping on different Uu frequencies or the Uu frequencies that they support for paging are not the same. In addition, if the remote UE switches its path from a direct path to the relay path, the NW may not be able to reach it as for paging Option 2 the NW may not know whether an idle/inactive remote UE is camping on a cell or a relay UE and may always page the remote UE on the Uu frequency(ies) that the remote UE camps on/supports, which may be different from the Uu frequency(ies) that the relay UE camps on/supports. Therefore, it may be desirable to study the above issue and develop corresponding solutions.

Various exemplary embodiments of the present disclosure propose mechanisms to enable paging for a remote UE when the remote UE and the corresponding relay UE are camping on different Uu frequencies or the Uu frequencies that they support are not the same. In accordance with an exemplary embodiment, when the Uu frequency(ies) that the remote UE camps on are not overlapped with the Uu frequency(ies) that the relay UE operates on, the relay UE may monitor paging for the remote UE in the Uu frequency(ies) that the remote UE camps on. Alternatively or additionally, the relay UE may inform a gNB to page the relay UE in the Uu frequency(ies) that the relay UE operates on. In accordance with another exemplary embodiment, one or more specific Uu frequency(ies) may be (pre) configured, and a gNB may always page a remote UE in (at least) the specific Uu frequency(ies) while a relay UE may always monitor paging for the remote UE(s) in the specific Uu frequency(ies).

According to an exemplary embodiment, the remote UE and/or the relay UE may indicate the Uu frequency information over PC5 link. In an embodiment, the Uu frequency information may comprise:
the Uu frequency(ies) that the remote UE and/or the relay UE operates on;
the Uu frequency band(s) supported by the remote UE and/or the relay UE; and/or
the capability to monitor paging for the remote UE in the specific Uu frequency(ies).

In an embodiment, a relay UE may be deprioritized in relay (re) selection, if the relay UE is not able to monitor paging for the remote UE. In another embodiment, a remote UE may trigger relay reselection and/or cell reselection, if the linked relay UE is not able to monitor paging for the remote UE. According to an exemplary embodiment, the remote UE may be kept in RRC connected state, if the remote UE may not be reached when in RRC idle/inactive state due to e.g. no cell or no relay UE that can monitor paging for the remote UE can be found.

Many advantages may be achieved by applying the proposed mechanisms. For example, a remote UE may be properly paged via a relay UE even if the remote UE and the relay UE are camping on different Uu frequencies or the Uu frequencies that they support are not the same. This can ensure reachability of the remote UE, which may be an important functionality that the relay UE may need to support.

It can be appreciated that although some exemplary embodiments are described in the context of NR random access technology (RAT), various embodiments described in the present disclosure may be in general applicable to any kind of communication scenarios involving D2D communications. For example, various embodiments described in the present disclosure may also be applicable to LTE RAT and any other RAT enabling direct communication between two (or more) nearby devices without any loss of meaning.

Various embodiments described in the present disclosure may be applicable to L2 based UE-to-NW relay scenarios. It can be appreciated that the connection between a remote UE and a relay UE may not be limited to sidelink. Any short-range communication technology such as wireless fidelity (WiFi) may also be equally applicable.

In various embodiments described in the present disclosure, the term “remote UE” may also be referred to as “RM UE” and the term “UE-to-NW relay UE” may also be referred to as “RL UE”. The RM UE may be able to transmit/receive packet to/from a base station such as a gNB, e.g., via an intermediate mobile terminal such as a RL UE.

In accordance with an exemplary embodiment, a RM UE may indicate in a discovery message (e.g., in discovery solicitation, etc.) the Uu frequency(ies) that the RM UE camps on when in RRC idle/inactive state (it can be appreciated that the RM UE may currently be in RRC connected state) and/or the Uu frequency bands that the RM UE may be able to support (for paging). Similarly, a RL UE may indicate in a discovery message (e.g., in discovery announcement and/or relay discovery additional information, etc.) the Uu frequency(ies) that the RL UE operates on and/or the Uu frequency bands that the RL UE may be able to support (for paging). According to an exemplary embodiment, it may be (pre) configured which UE (e.g., the RM UE, the RL UE or both) may need to indicate such frequency information, and/or when the frequency information may need to be indicated. In an embodiment, the RM UE may only indicate such frequency information when in RRC idle/inactive state, and absence of such frequency information (e.g., in the discovery message) may imply that the RM UE is in RRC connected state.

It can be appreciated that in various embodiments, the Uu frequency(ies) of a RL UE may refer to the Uu frequency(ies) that the RL UE operates on and/or the Uu frequency bands that the RL UE may be able to support (for paging), while the Uu frequency(ies) of a RM UE may be refer to the Uu frequency(ies) that the RM UE camps on when in RRC idle/inactive state and/or the Uu frequency bands that the RM UE may be able to support (for paging).

In accordance with an exemplary embodiment, a RL UE may be deprioritized in relay (re) selection for a RM UE if the Uu frequency(ies) of the RL UE are not overlapped with the Uu frequency(ies) of the RM UE. More specifically, the RM UE may first select from the RL UE(s) with the same or overlapped Uu frequency(ies), or a relative priority may be given to those RL UE(s), e.g., by adding a (pre) configured positive offset to the SL quality measurement of those RL UEs so that they are more likely to be selected. In an embodiment, a RL UE may not send a discovery response message to a RM UE with different or non-overlapped Uu frequency(ies).

In accordance with an exemplary embodiment, when a RM UE linked to a RL UE, the RM UE may inform its Uu frequency(ies) to the linked RL UE, either proactively or based on a request from the RL UE. Similarly, a RL UE may inform its Uu frequency(ies) to a RM UE, either proactively or based on a request from the RM UE. In an embodiment, when receiving the frequency information from the peer UE, the RM UE may send a response which may indicate whether its Uu frequency(ies) are the same or overlapped with the Uu frequency(ies) of the peer UE. In another embodiment, when receiving the frequency information from the peer UE, the RL UE may send a response which may indicate: whether the Uu frequency(ies) of the RL UE are the same or overlapped with the Uu frequency(ies) of the peer UE, and/or whether the RL UE will/can monitor paging for the RM UE, etc. Alternatively or additionally, the response from the RL UE may indicate in which frequency(ies) the RL UE will/can do the monitoring for the RM UE. According to an exemplary embodiment, this kind of information may be sent to the RM UE again by the RL UE, when the RL UE will not/cannot monitor paging for the RM UE while previously it was monitoring the paging for the RM UE, and vice versa.

In accordance with an exemplary embodiment, when the Uu frequency(ies) that a RM UE camps on are not overlapped with the Uu frequency(ies) that a RL UE operates on, the RL UE may choose to monitor paging for the RM UE in the Uu frequency(ies) that the RM UE camps on if that is feasible (e.g., the Uu frequency bands supported (for paging) by the RL UE is overlapped with those supported (for paging) by the RM UE).

In accordance with an exemplary embodiment, a RL UE may inform a gNB the PagingUE-Identity (e.g., ng-5G-serving-temporary mobile subscriber identity (ng-5G-S-TMSI), full inactive-radio network temporary identifier (fullI-RNTI), etc.) of a RM UE. The RL UE may obtain the PagingUE-Identity from the RM UE via e.g. PC5-RRC. In the case that the RL UE is in RRC idle/inactive state, the RL UE may do the informing via small data transmission, e.g., by including the ID in the rrcResumeRequest or rrcSetupRequest message, or in the data part which is transmitted together with the CP signaling. The gNB may store an association between the PagingUE-Identity of the RM UE and the ID (e.g. PagingUE-Identity or cell-radio network temporary identifier (C-RNTI), etc.) of the RL UE. In an embodiment, the gNB may page the RM UE in the RL UE's Uu frequency(ies), when receiving a paging message for the RM UE from AMF or the last serving gNB of the RM UE. In another embodiment, the gNB may send the association between the PagingUE-Identity of the RM UE and the Uu frequency(ies) in which the RM UE is to be paged to the last serving gNB or the AMF of the RM UE (potentially via the AMF of the RL UE), which in turn may send the association to all the gNBs in the RAN notification area or the registration area of the RM UE. As such, all those gNBs may page the RM UE in the associated Uu frequency(ies) (e.g., the RL UE's Uu frequency(ies), etc.).

In accordance with an exemplary embodiment, one or more specific Uu frequency(ies) may be (pre) configured for a RM UE, and a gNB may always page the RM UE in (at least) those specific Uu frequency(ies). Correspondingly, when a RL UE having one or more RM UE(s) linked to it, the RL UE may always monitor paging for the RM UE(s) in those specific Uu frequency(ies). The RM UE and/or the RL UE may obtain configuration on the specific Uu frequency(ies), e.g., via a system information block (SIB) or dedicated RRC message from the gNB or via NAS message from a core NW node such as AMF. In an embodiment, the RM UE may inform the gNB (potentially via the RL UE) whether it reselects a RL UE while currently camping on a cell and vice versa. In another embodiment, the RM UE and the RL UE in RRC idle/inactive state may do the informing via small data transmission. For example, a new resumeCause or establishmentCause may be introduced in the rrcResumeRequest or rrcSetupRequest message to indicate that the RM UE performs a reselection from the RL UE to a cell or from a cell to a RL UE. According to an embodiment, the gNB may page the RM UE only in the specific Uu frequency(ies) or the Uu frequency(ies) that the RM UE camps on/supports (for paging), depending on whether the RM UE (re) selects a RL UE or a cell.

In accordance with an exemplary embodiment, a RL UE may indicate in a discovery message (e.g., in discovery announcement and/or relay discovery additional information, etc.), or inform the linked RM UE whether it can/will monitor paging in the specific Uu frequency(ies), e.g., either proactively or based on a request.

In accordance with an exemplary embodiment, a RL UE may be deprioritized in relay (re) selection for a RM UE, if the RL UE cannot/will not monitor paging for the RM UE in the specific Uu frequency(ies).

In accordance with an exemplary embodiment, in the case that a RL UE will not/cannot monitor paging for a RM UE, the RM UE may trigger a relay reselection procedure and/or a cell reselection procedure to select another RL UE or a cell for the RM UE. In the case that no other suitable RL UE that will/can monitor paging for the RM UE or no cell for the RM UE can be found, the RM UE may inform this to the current RL UE, and the RL UE may start to monitor paging for the RM UE when this is/becomes feasible.

In accordance with an exemplary embodiment, when a gNB instructs a RM UE currently in RRC connected state to RRC idle/inactive state, the gNB may indicate, e.g., in the RRCRelease message, a list of RL UEs that the RM UE may (re) select, and/or a list of RL UEs that the RM UE may not (re) select after entering the RRC idle/inactive state. In an embodiment, the gNB may determine such list(s) based on the supported Uu frequency(ies) (for paging) that may be informed by the RM UE and/or the RL UE(s) (e.g. in the UECapabilityInformation message, etc.), and/or one or more neighbor gNBs, and/or one or more core NW nodes such as AMF, etc.

In accordance with an exemplary embodiment, in the case that a RM UE in RRC idle/inactive state cannot find a RL UE that will/can monitor paging for the RM UE or a suitable cell for the RM UE, and the situation persists for more than a (pre) configured period, the RM UE may enter the RRC connected state via a RL UE it selects. In an embodiment, when in the RRC connected state, the RM UE may indicate to a gNB: whether the RM UE can find a RL UE that will/can monitor paging for the RM UE and has good enough PC5 link quality to it (e.g., the measured PC5 RSRP is higher than a (pre) configured threshold, etc.), and/or whether the RM UE can find a cell with good enough Uu link quality to it (e.g., the measured Uu RSRP is higher than another (pre) configured threshold, etc.). Alternatively or additionally, the RM UE may indicate in its measurement report whether the RL UE(s) included in the measurement report will/can monitor paging for the RM UE. Based on such information, the gNB may keep the RM UE in the RRC connected state if the gNB determines that the RM UE cannot be reached when in RRC idle/inactive state.

In accordance with an exemplary embodiment, the signaling between a UE (e.g., a RM UE and a RL UE) and a gNB may be implemented in one or more of the following ways:
common and/or dedicated RRC signaling;
a MAC CE;
a paging message;
a control PDU of a protocol layer (e.g., service data adaptation protocol (SDAP) layer, packet data convergence protocol (PDCP) layer, radio link control (RLC) layer, or an adaptation layer in case of SL relay, etc.); and
L1 signaling on channels such as physical random access channel (PRACH), PUCCH, or PDCCH, etc.

In accordance with an exemplary embodiment, the signaling between UEs such as a RM UE and a RL UE may be implemented in one or more of the following ways:
RRC signaling (e.g., PC5-RRC signaling, etc.);
PC5-S signaling;
discovery signaling;
a MAC CE;
a control PDU of a protocol layer (e.g., SDAP, PDCP, RLC, or an adaptation layer in case of SL relay); and
L1 signaling on channels such as PSSCH, PSCCH, or PSFCH, etc.

It is noted that some embodiments of the present disclosure are mainly described in relation to 4G/LTE or 5G/NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

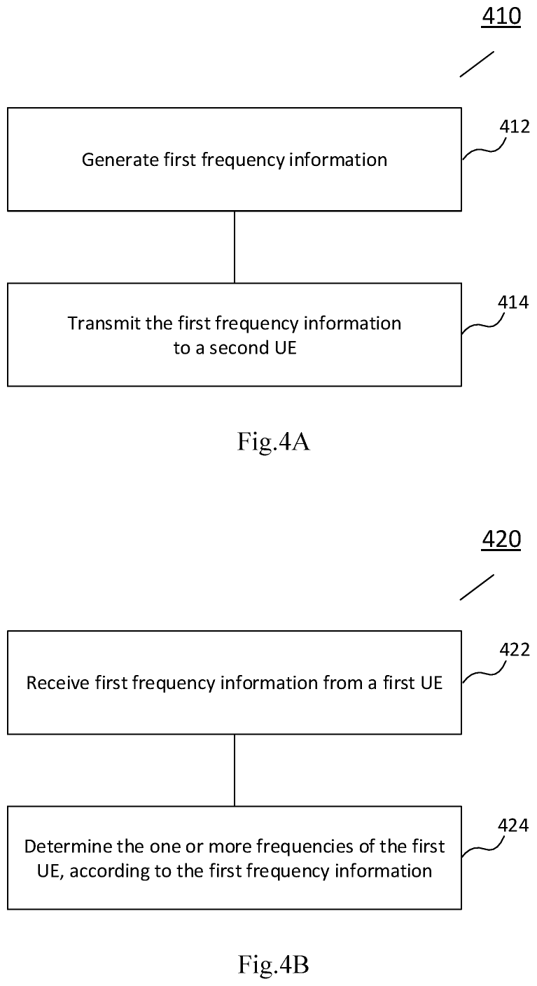

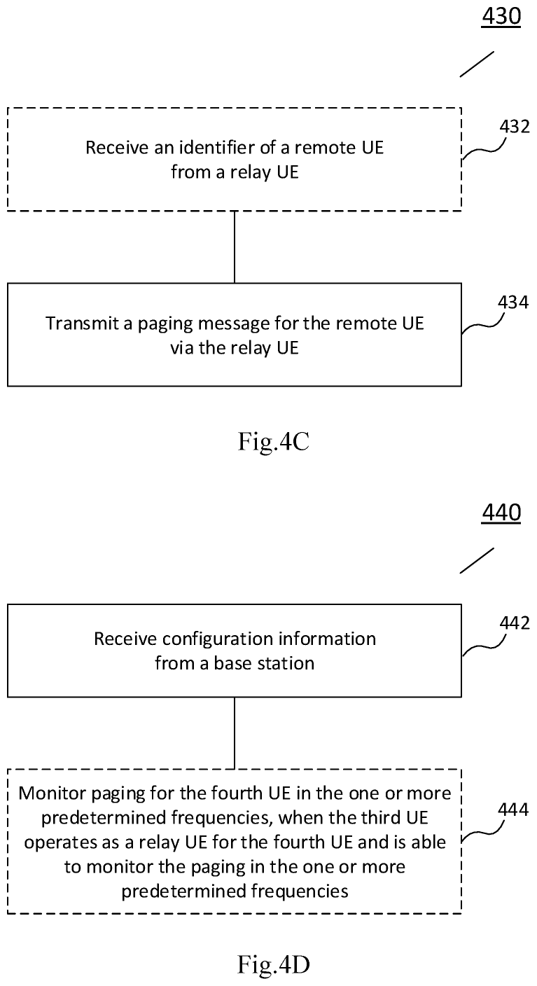

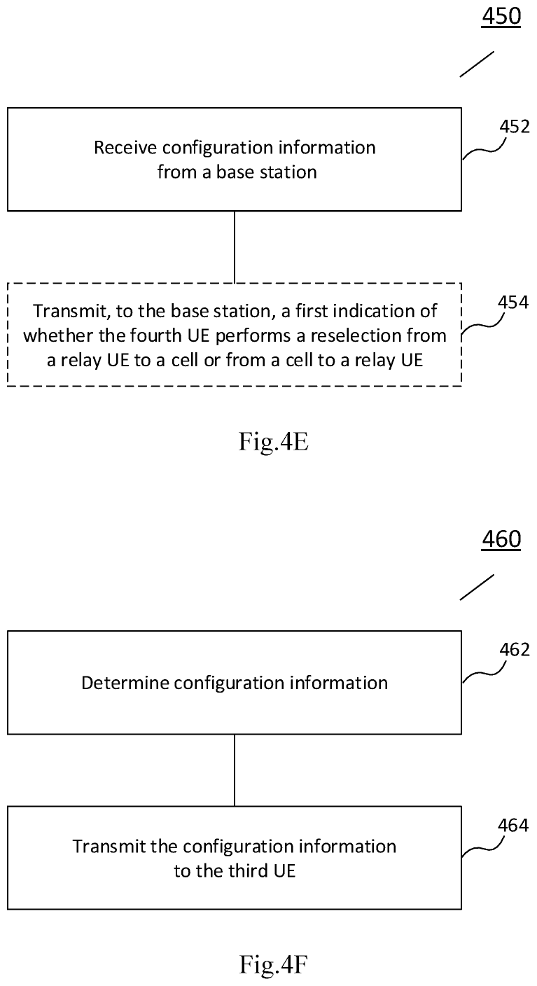

FIG. 4A is a flowchart illustrating a method 410 according to some embodiments of the present disclosure. The method 410 illustrated in FIG. 4A may be performed by a first UE or an apparatus communicatively coupled to the first UE. In accordance with an exemplary embodiment, the first UE may be configured to support D2D communication (e.g., V2X or SL communication, etc.) with other devices. In an exemplary embodiment, the first UE may be configured to communicate with a network node (e.g., a base station such as gNB, etc.) directly or via a relay (e.g., a UE-to-NW relay, etc.).

According to the exemplary method 410 illustrated in FIG. 4A, the first UE may generate first frequency information, as shown in block 412. The first frequency information may indicate one or more frequencies of the first UE. In accordance with an exemplary embodiment, the first UE may transmit the first frequency information to a second UE, as shown in block 414.

In accordance with an exemplary embodiment, the first frequency information may be transmitted to the second UE in a discovery message. In accordance with another exemplary embodiment, when the first UE is linked to the second UE, the first frequency information may be transmitted to the second UE proactively or in response to a request from the second UE.

In accordance with an exemplary embodiment, the first UE may operate as a remote UE, and the second UE may operate as a relay UE for the first UE.

In accordance with an exemplary embodiment, the one or more frequencies of the first UE may comprise: one or more Uu frequencies which the first UE camps on when the first UE is in an RRC idle/inactive state; and/or one or more Uu frequency bands which the first UE is able to support for paging, etc.

In accordance with an exemplary embodiment, the first UE may receive, from the second UE, one or more of:
second frequency information indicating one or more frequencies of the second UE;
an indication of whether the one or more frequencies of the first UE are overlapped with the one or more frequencies of the second UE;
an indication of whether the second UE is able to monitor paging for the first UE; and
an indication of one or more frequencies in which the second UE is able to monitor the paging for the first UE.

In accordance with an exemplary embodiment, the one or more frequencies of the second UE may comprise: one or more Uu frequencies which the second UE operates on; and/or one or more Uu frequency bands which the second UE is able to support for paging, etc.

In accordance with an exemplary embodiment, the first UE may deprioritize the second UE in relay selection or reselection for the first UE, when the one or more frequencies of the first UE are not overlapped with one or more frequencies of the second UE.

In accordance with an exemplary embodiment, the first UE may trigger a relay reselection procedure to select another relay UE for the first UE and/or a cell reselection procedure to select a cell for the first UE, when the second UE is not able to monitor paging for the first UE.

In accordance with an exemplary embodiment, the first UE may transmit event information to the second UE. In an embodiment, the event information may indicate that no other relay UE being able to monitor the paging for the first UE is selected by using the relay reselection procedure, and/or that no cell is selected for the first UE by using the cell reselection procedure.

In accordance with an exemplary embodiment, the first UE may enter an RRC connected state from an RRC idle/inactive state, when an event persists for a predetermined period. In an embodiment, the event may include that no other relay UE being able to monitor the paging for the first UE is selected by using the relay reselection procedure, and/or that no cell is selected for the first UE by using the cell reselection procedure.

In accordance with an exemplary embodiment, the first UE may transmit, to a base station, information about one or more of:
whether the first UE is able to find a relay UE which is able to monitor paging for the first UE and has PC5 link quality higher than a first threshold;
whether the first UE is able to find a cell which has Uu link quality higher than a second threshold; and
whether one or more relay UEs included in a measurement report of the first UE are able to monitor the paging for the first UE.

In accordance with an exemplary embodiment, the first UE may receive, from a base station, information about a first list of relay UEs and/or a second list of relay UEs. In an embodiment, the first list of relay UEs may include one or more relay UEs available for the first UE in an RRC idle/inactive state, and the second list of relay UEs may include one or more relay UEs not available for the first UE in an RRC idle/inactive state.

In accordance with an exemplary embodiment, the first UE may operate as a relay UE for the second UE, and the second UE may operate as a remote UE. In this case, the one or more frequencies of the first UE may comprise: one or more Uu frequencies which the first UE operates on; and/or one or more Uu frequency bands which the first UE is able to support for paging, etc.

In accordance with an exemplary embodiment, the first UE may receive, from the second UE, one or more of:
second frequency information indicating one or more frequencies of the second UE (e.g., one or more Uu frequencies which the second UE camps on when the second UE is in an RRC idle/inactive state; and/or one or more Uu frequency bands which the second UE is able to support for paging, etc.); and
an indication of whether the one or more frequencies of the first UE are overlapped with the one or more frequencies of the second UE.

In accordance with an exemplary embodiment, when one or more Uu frequencies which the second UE camps on are not overlapped with one or more Uu frequencies which the first UE operates on, the first UE may select to monitor paging for the second UE in the one or more Uu frequencies which the second UE camps on, when the one or more Uu frequencies which the second UE camps on are supported for paging by the first UE.

In accordance with an exemplary embodiment, the first UE may transmit an identifier of the second UE to a base station. According to an embodiment, the first UE may select to monitor paging for the second UE in one or more Uu frequencies which the first UE operates on and/or are supported for paging by the first UE.

In accordance with an exemplary embodiment, when the first UE is not able to monitor paging for the second UE, the first UE may receive event information from the second UE. In an embodiment, the event information may indicate that no other relay UE being able to monitor the paging for the second UE is selected by using a relay reselection procedure of the second UE, and/or that no cell is selected for the second UE by using a cell reselection procedure of the second UE.

In accordance with an exemplary embodiment, when the first UE becomes to be capable of monitoring the paging for the second UE, the first UE may start to monitor the paging for the second UE.

In accordance with an exemplary embodiment, the first UE may communicate with the second UE by using one or more of:
RRC signaling;
PC5-S signaling;
discovery signaling;
a MAC CE;
a PDU of a protocol layer; and
L1 signaling on sidelink channels.

In accordance with an exemplary embodiment, the first UE and/or the second UE may communicate with a base station by using one or more of:
RRC signaling;
a MAC CE;
a paging message;
a PDU of a protocol layer; and
L1 signaling.

FIG. 4B is a flowchart illustrating a method 420 according to some embodiments of the present disclosure. The method 420 illustrated in FIG. 4B may be performed by a second UE or an apparatus communicatively coupled to the second UE. In accordance with an exemplary embodiment, the second UE may be configured to support D2D communication (e.g., V2X or SL communication, etc.) with other devices. In an exemplary embodiment, the second UE may be configured to communicate with a network node (e.g., a base station such as gNB, etc.) directly or via a relay (e.g., a UE-to-NW relay, etc.).

According to the exemplary method 420 illustrated in FIG. 4B, the second UE may receive first frequency information from a first UE (e.g., the first UE as described with respect to FIG. 4A), as shown in block 422. The first frequency information may indicate one or more frequencies of the first UE. According to the first frequency information, the second UE can determine the one or more frequencies of the first UE, as shown in block 424.

In accordance with an exemplary embodiment, the first frequency information may be received from the first UE in a discovery message. Alternatively or additionally, when the second UE is linked to the first UE, the first frequency information may be transmitted by the first UE proactively or in response to a request from the second UE, as described with respect to FIG. 4A.

In accordance with an exemplary embodiment, the first frequency information as described according to the method 420 may correspond to the first frequency information as described according to the method 410. Thus, the first frequency information as described with respect to FIG. 4A and FIG. 4B may have the same or similar contents and/or feature elements.

In accordance with an exemplary embodiment, the second UE may operate as a relay UE for the first UE, and the first UE may operate as a remote UE. In this case, the one or more frequencies of the first UE may comprise: one or more Uu frequencies which the first UE camps on when the first UE is in an RRC idle/inactive state; and/or one or more Uu frequency bands which the first UE is able to support for paging, etc.

In accordance with an exemplary embodiment, the second UE may transmit, to the first UE, one or more of:
second frequency information indicating one or more frequencies of the second UE (e.g., one or more Uu frequencies which the second UE operates on, and/or one or more Uu frequency bands which the second UE is able to support for paging, etc.);
an indication of whether the one or more frequencies of the first UE are overlapped with the one or more frequencies of the second UE;
an indication of whether the second UE is able to monitor paging for the first UE; and
an indication of one or more frequencies in which the second UE is able to monitor the paging for the first UE.

In accordance with an exemplary embodiment, the second frequency information as described according to the method 420 may correspond to the second frequency information as described according to the method 410. Thus, the second frequency information as described with respect to FIG. 4A and FIG. 4B may have the same or similar contents and/or feature elements.

In accordance with an exemplary embodiment, when one or more Uu frequencies which the first UE camps on are not overlapped with one or more Uu frequencies which the second UE operates on, the second UE may select to monitor paging for the first UE in the one or more Uu frequencies which the first UE camps on, when the one or more Uu frequencies which the first UE camps on are supported for paging by the second UE.

In accordance with an exemplary embodiment, the second UE may transmit an identifier of the first UE to a base station. In an embodiment, the second UE may select to monitor paging for the first UE in one or more Uu frequencies which the second UE operates on and/or are supported for paging by the second UE.

In accordance with an exemplary embodiment, when the second UE is not able to monitor paging for the first UE, the second UE may receive event information from the first UE. In an embodiment, the event information may indicate that no other relay UE being able to monitor the paging for the first UE is selected by using a relay reselection procedure of the first UE, and/or that no cell is selected for the first UE by using a cell reselection procedure of the first UE.

In accordance with an exemplary embodiment, the second UE may start to monitor the paging for the first UE, when the second UE becomes to be capable of monitoring the paging for the first UE.

In accordance with an exemplary embodiment, the second UE may operate as a remote UE, and the first UE may operate as a relay UE for the second UE. In this case, the one or more frequencies of the first UE may comprise: one or more Uu frequencies which the first UE operates on; and/or one or more Uu frequency bands which the first UE is able to support for paging, etc.

In accordance with an exemplary embodiment, the second UE may transmit, to the first UE, one or more of:
second frequency information indicating one or more frequencies of the second UE (e.g., one or more Uu frequencies which the second UE camps on when the second UE is in an RRC idle/inactive state; and/or one or more Uu frequency bands which the second UE is able to support for paging, etc.); and
an indication of whether the one or more frequencies of the first UE are overlapped with the one or more frequencies of the second UE.

In accordance with an exemplary embodiment, when the one or more frequencies of the first UE are not overlapped with one or more frequencies of the second UE, the second UE may deprioritize the first UE in relay selection or reselection for the second UE.

In accordance with an exemplary embodiment, when the first UE is not able to monitor the paging for the second UE, the second UE may trigger a relay reselection procedure to select another relay UE for the second UE and/or a cell reselection procedure to select a cell for the second UE.

In accordance with an exemplary embodiment, the second UE may transmit event information to the first UE. In an embodiment, the event information may indicate that no other relay UE being able to monitor the paging for the second UE is selected by using the relay reselection procedure, and/or that no cell is selected for the second UE by using the cell reselection procedure.

In accordance with an exemplary embodiment, the second UE may enter an RRC connected state from an RRC idle/inactive state, when an event persists for a predetermined period. In an embodiment, the event may include that no other relay UE being able to monitor the paging for the second UE is selected by using the relay reselection procedure, and/or that no cell is selected for the second UE by using the cell reselection procedure.

In accordance with an exemplary embodiment, the second UE may transmit, to a base station, information about one or more of:
whether the second UE is able to find a relay UE which is able to monitor paging for the second UE and has PC5 link quality higher than a third threshold;
whether the second UE is able to find a cell which has Uu link quality higher than a fourth threshold; and
whether one or more relay UEs included in a measurement report of the second UE are able to monitor the paging for the second UE.

In accordance with an exemplary embodiment, the second UE may receive, from a base station, information about a third list of relay UEs and/or a fourth list of relay UEs. In an embodiment, the third list of relay UEs may include one or more relay UEs available for the second UE in an RRC idle/inactive state, and the fourth list of relay UEs may include one or more relay UEs not available for the second UE in an RRC idle/inactive state.

FIG. 4C is a flowchart illustrating a method 430 according to some embodiments of the present disclosure. The method 430 illustrated in FIG. 4C may be performed by a base station (e.g., a gNB, an AP, etc.) or an apparatus communicatively coupled to the base station. In accordance with an exemplary embodiment, the base station may be configured to support cellular coverage extension with D2D communication (e.g., V2X or SL communication, etc.). In an exemplary embodiment, the base station may be configured to communicate with a terminal device such as a UE, e.g. directly or via a relay.

According to the exemplary method 430 illustrated in FIG. 4C, the base station may transmit a paging message for a remote UE via a relay UE, as shown in block 434. In an embodiment, frequency information of the remote UE and/or frequency information of the relay UE may be exchanged between the remote UE and the relay UE.

In accordance with an exemplary embodiment, the frequency information of the remote UE may indicate: one or more Uu frequencies which the remote UE camps on when the remote UE is in an RRC idle/inactive state; and/or one or more Uu frequency bands which the remote UE is able to support for paging.

In accordance with an exemplary embodiment, the frequency information of the relay UE may indicate: one or more Uu frequencies which the relay UE operates on; and/or one or more Uu frequency bands which the relay UE is able to support for paging.

In accordance with an exemplary embodiment, the remote UE as described according to the method 430 may correspond to the first UE as described according to the method 410, and the relay UE as described according to the method 430 may correspond to the second UE as described according to the method 420.

In accordance with another exemplary embodiment, the remote UE as described according to the method 430 may correspond to the second UE as described according to the method 420, and the relay UE as described according to the method 430 may correspond to the first UE as described according to the method 410.

In accordance with an exemplary embodiment, the paging message may be transmitted in one or more Uu frequencies which the remote UE camps on and are supported for paging by the relay UE.

In accordance with an exemplary embodiment, the base station may optionally receive an identifier of the remote UE from the relay UE, as shown in block 432. In this case, the paging message may be transmitted in one or more Uu frequencies which the relay UE operates on and/or are supported for paging by the relay UE.

In accordance with an exemplary embodiment, the base station may inform another base station and/or a core network node of an association between the identifier of the remote UE and one or more Uu frequencies in which the remote UE is to be paged.

In accordance with an exemplary embodiment, the base station may transmit, to the remote UE, information about a fifth list of relay UEs and/or a sixth list of relay UEs. In an embodiment, the fifth list of relay UEs may include one or more relay UEs available for the remote UE in an RRC idle/inactive state, and the sixth list of relay UEs may include one or more relay UEs not available for the remote UE in an RRC idle/inactive state.

In accordance with an exemplary embodiment, the fifth list of relay UEs and/or the sixth list of relay UEs may be determined by the base station based at least in part on frequency information provided by: the remote UE; one or more relay UEs for the remote UE; one or more other base stations; and/or one or more core network nodes.

In accordance with an exemplary embodiment, the base station may receive, from the remote UE, information about one or more of:
whether the remote UE is able to find a relay UE which is able to monitor paging for the remote UE and has PC5 link quality higher than a fifth threshold;
whether the remote UE is able to find a cell which has Uu link quality higher than a sixth threshold; and
whether one or more relay UEs included in a measurement report of the remote UE are able to monitor the paging for the remote UE.

In accordance with an exemplary embodiment, according to the information received from the remote UE, the base station may determine whether the base station is able to reach the remote UE in an RRC idle/inactive state. When determining that the base station is not able to reach the remote UE in the RRC idle/inactive state, the base station may keep the remote UE in an RRC connected state.

In accordance with an exemplary embodiment, the base station may communicate with the remote UE and/or the relay UE by using RRC signaling, a MAC CE, a paging message, a PDU of a protocol layer, and/or L1 signaling, etc.

FIG. 4D is a flowchart illustrating a method 440 according to some embodiments of the present disclosure. The method 440 illustrated in FIG. 4D may be performed by a third UE or an apparatus communicatively coupled to the third UE. In accordance with an exemplary embodiment, the third UE may be configured to support D2D communication (e.g., V2X or SL communication, etc.) with other devices. In an exemplary embodiment, the third UE may be configured to communicate with a network node (e.g., a base station such as gNB, etc.) directly or via a relay (e.g., a UE-to-NW relay, etc.).

According to the exemplary method 440 illustrated in FIG. 4D, the third UE may receive configuration information from a base station, as shown in block 442. In accordance with an exemplary embodiment, the configuration information may indicate one or more predetermined frequencies in which a fourth UE is to be paged via the third UE.

In accordance with an exemplary embodiment, the third UE may receive, from the fourth UE, a first indication of whether the fourth UE performs a reselection from a relay UE to a cell or from a cell to a relay UE. In an embodiment, the third UE may forward the first indication from the fourth UE to the base station.

In accordance with an exemplary embodiment, when the third UE operates as a relay UE for the fourth UE and is able to monitor the paging in the one or more predetermined frequencies, the third UE may monitor paging for the fourth UE in the one or more predetermined frequencies, as shown in block 444.

In accordance with an exemplary embodiment, the third UE may transmit, to the fourth UE, a second indication of whether the third UE is able to monitor paging for the fourth UE in the one or more predetermined frequencies, and/or a third indication of one or more frequencies in which the third UE is able to monitor the paging for the fourth UE.

In accordance with an exemplary embodiment, when the third UE is not able to monitor paging for the fourth UE in the one or more predetermined frequencies, the third UE may receive event information from the fourth UE. In an embodiment, the event information may indicate that no other relay UE being able to monitor the paging for the fourth UE is selected by using a relay reselection procedure of the fourth UE, and/or that no cell is selected for the fourth UE by using a cell reselection procedure of the fourth UE.

In accordance with an exemplary embodiment, when the third UE becomes to be capable of monitoring the paging in the one or more predetermined frequencies, the third UE may start to monitor the paging for the fourth UE in the one or more predetermined frequencies.

In accordance with an exemplary embodiment, the third UE may communicate with the fourth UE by using RRC signaling, PC5-S signaling, discovery signaling, a MAC CE, a PDU of a protocol layer, and/or L1 signaling on sidelink channels, etc.

In accordance with an exemplary embodiment, the third UE and/or the fourth UE may communicate with the base station by using RRC signaling, a MAC CE, a paging message, a PDU of a protocol layer, and/or L1 signaling, etc.

FIG. 4E is a flowchart illustrating a method 450 according to some embodiments of the present disclosure. The method 450 illustrated in FIG. 4E may be performed by a fourth UE or an apparatus communicatively coupled to the fourth UE. In accordance with an exemplary embodiment, the fourth UE may be configured to support D2D communication (e.g., V2X or SL communication, etc.) with other devices. In an exemplary embodiment, the fourth UE may be configured to communicate with a network node (e.g., a base station such as gNB, etc.) directly or via a relay (e.g., a UE-to-NW relay, etc.).

According to the exemplary method 450 illustrated in FIG. 4E, the fourth UE may receive configuration information from a base station, as shown in block 452. In accordance with an exemplary embodiment, the configuration information may indicate one or more predetermined frequencies in which the fourth UE is to be paged via a third UE (e.g., the third UE as described with respect to FIG. 4D).

In accordance with an exemplary embodiment, the configuration information as described according to the method 450 may correspond to the configuration information as described according to the method 440. Thus, the configuration information as described with respect to FIG. 4D and FIG. 4E may have the same or similar contents and/or feature elements.

In accordance with an exemplary embodiment, the fourth UE may transmit, to the base station, a first indication of whether the fourth UE performs a reselection from a relay UE to a cell or from a cell to a relay UE, as shown in block 454.

In accordance with an exemplary embodiment, when the fourth UE performs a reselection from a relay UE to a cell, the fourth UE may monitor paging for the fourth UE in one or more Uu frequencies which the fourth UE camps on and/or supports for paging.

In accordance with an exemplary embodiment, the fourth UE may receive, from the third UE, a second indication of whether the third UE is able to monitor paging for the fourth UE in the one or more predetermined frequencies, and/or a third indication of one or more frequencies in which the third UE is able to monitor the paging for the fourth UE.

In accordance with an exemplary embodiment, when the third UE is not able to monitor the paging for the fourth UE in the one or more predetermined frequencies, the fourth UE may deprioritize the third UE in relay selection or reselection for the fourth UE.

In accordance with an exemplary embodiment, when the third UE is not able to monitor the paging for the fourth UE in the one or more predetermined frequencies, the fourth UE may trigger a relay reselection procedure to select another relay UE for the fourth UE and/or a cell reselection procedure to select a cell for the fourth UE.

In accordance with an exemplary embodiment, the fourth UE may transmit event information to the third UE. In an embodiment, the event information may indicate that no other relay UE being able to monitor the paging for the fourth UE is selected by using the relay reselection procedure, and/or that no cell is selected for the fourth UE by using the cell reselection procedure.

In accordance with an exemplary embodiment, the fourth UE may enter an RRC connected state from an RRC idle/inactive state, when an event persists for a predetermined period. In an embodiment, the event may include that no other relay UE being able to monitor the paging for the fourth UE is selected by using the relay reselection procedure, and/or that no cell is selected for the fourth UE by using the cell reselection procedure.

In accordance with an exemplary embodiment, the fourth UE may transmit, to the base station, information about one or more of:
whether the fourth UE is able to find a relay UE which is able to monitor paging for the fourth UE and has PC5 link quality higher than a seventh threshold;
whether the fourth UE is able to find a cell which has Uu link quality higher than an eighth threshold; and
whether one or more relay UEs included in a measurement report of the fourth UE are able to monitor the paging for the fourth UE.

In accordance with an exemplary embodiment, the fourth UE may receive, from the base station, information about a seventh list of relay UEs and/or an eighth list of relay UEs. In an embodiment, the seventh list of relay UEs may include one or more relay UEs available for the fourth UE in an RRC idle/inactive state, and the eighth list of relay UEs may include one or more relay UEs not available for the fourth UE in an RRC idle/inactive state.

FIG. 4F is a flowchart illustrating a method 460 according to some embodiments of the present disclosure. The method 460 illustrated in FIG. 4F may be performed by a base station (e.g., a gNB, an AP, etc.) or an apparatus communicatively coupled to the base station. In accordance with an exemplary embodiment, the base station may be configured to support cellular coverage extension with D2D communication (e.g., V2X or SL communication, etc.). In an exemplary embodiment, the base station may be configured to communicate with a terminal device such as a UE, e.g. directly or via a relay.

According to the exemplary method 460 illustrated in FIG. 4F, the base station may determine configuration information, as shown in block 462. The configuration information may indicate one or more predetermined frequencies in which a fourth UE is to be paged via a third UE. In accordance with an exemplary embodiment, the base station may transmit the configuration information to the third UE, as shown in block 464. Alternatively or additionally, the base station may transmit the configuration information to the fourth UE.

In accordance with an exemplary embodiment, the configuration information transmitted by the base station according to the method 460 may correspond to the configuration information received by the third UE according to the method 440 and the configuration information received by the fourth UE according to the method 450. Thus, the configuration information as described with respect to FIG. 4D, FIG. 4E and FIG. 4F may have the same or similar contents and/or feature elements.

In accordance with an exemplary embodiment, the base station may receive, from the fourth UE, a first indication of whether the fourth UE performs a reselection from a relay UE to a cell or from a cell to a relay UE.

In accordance with an exemplary embodiment, when the third UE operates as a relay UE for the fourth UE and is able to monitor paging in the one or more predetermined frequencies, the base station may transmit a paging message for the fourth UE in the one or more predetermined frequencies.

In accordance with an exemplary embodiment, when the fourth UE performs a reselection from the relay UE to the cell, the base station may transmit a paging message for the fourth UE in one or more Uu frequencies which the fourth UE camps on and/or supports for paging.

In accordance with an exemplary embodiment, the base station may transmit, to the fourth UE, information about a ninth list of relay UEs and/or a tenth list of relay UEs. In an embodiment, the ninth list of relay UEs may include one or more relay UEs available for the fourth UE in an RRC idle/inactive state, and the tenth list of relay UEs may include one or more relay UEs not available for the fourth UE in an RRC idle/inactive state.

In accordance with an exemplary embodiment, the ninth list of relay UEs and/or the tenth list of relay UEs may be determined by the base station based at least in part on frequency information provided by: the fourth UE; one or more relay UEs for the fourth UE; one or more other base stations; and/or one or more core network nodes, etc.

In accordance with an exemplary embodiment, the base station may receive, from the fourth UE, information about one or more of:
whether the fourth UE is able to find a relay UE which is able to monitor paging for the fourth UE and has PC5 link quality higher than a ninth threshold;
whether the fourth UE is able to find a cell which has Uu link quality higher than a tenth threshold; and
whether one or more relay UEs included in a measurement report of the fourth UE are able to monitor the paging for the fourth UE.

In accordance with an exemplary embodiment, according to the information received from the fourth UE, the base station may determine whether the base station is able to reach the fourth UE in an RRC idle/inactive state. When determining that the base station is not able to reach the fourth UE in the RRC idle/inactive state, the base station may keep the fourth UE in an RRC connected state.

It can be appreciated that the first, second, third, fourth, fifth, sixth, seventh, eighth, ninth and tenth thresholds as described according to various exemplary embodiments may be the same threshold or different thresholds. These thresholds may be configured and/or adjusted according to different application scenarios and service requirements.

It can be appreciated that the first UE as described with respect to FIG. 4A may also be configured to perform the method 420 as described with respect to FIG. 4B, the method 440 as described with respect to FIG. 4D, or the method 450 as described with respect to FIG. 4E, according to different application scenarios and service requirements.

Similarly, it can be appreciated that the second UE as described with respect to FIG. 4B may also be configured to perform the method 410 as described with respect to FIG. 4A, the method 440 as described with respect to FIG. 4D, or the method 450 as described with respect to FIG. 4E, according to different application scenarios and service requirements.

Similarly, it can be appreciated that the third UE as described with respect to FIG. 4D may also be configured to perform the method 410 as described with respect to FIG. 4A, the method 420 as described with respect to FIG. 4B, and the method 450 as described with respect to FIG. 4E, according to different application scenarios and service requirements.

Similarly, it can be appreciated that the fourth UE as described with respect to FIG. 4E may also be configured to perform the method 410 as described with respect to FIG. 4A, the method 420 as described with respect to FIG. 4B, and the method 440 as described with respect to FIG. 4D, according to different application scenarios and service requirements.

It also can be appreciated that the base station as described with respect to FIG. 4C may also be configured to perform the method 460 as described with respect to FIG. 4F, according to different application scenarios and service requirements. Similarly, it can be appreciated that the base station as described with respect to FIG. 4F may also be configured to perform the method 430 as described with respect to FIG. 4C, according to different application scenarios and service requirements.

The various blocks shown in FIGS. 4A-4F may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

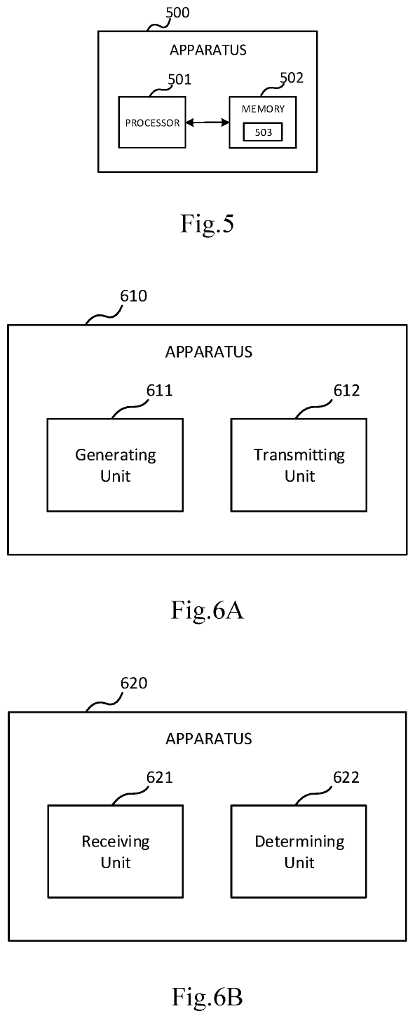

FIG. 5 is a block diagram illustrating an apparatus 500 according to various embodiments of the present disclosure. As shown in FIG. 5, the apparatus 500 may comprise one or more processors such as processor 501 and one or more memories such as memory 502 storing computer program codes 503. The memory 502 may be non-transitory machine/processor/computer readable storage medium. In accordance with some exemplary embodiments, the apparatus 500 may be implemented as an integrated circuit chip or module that can be plugged or installed into a first UE as described with respect to FIG. 4A, a second UE as described with respect to FIG. 4B, a base station as described with respect to FIG. 4C, a third UE as described with respect to FIG. 4D, a fourth UE as described with respect to FIG. 4E, or a base station as described with respect to FIG. 4F. In such cases, the apparatus 500 may be implemented as a first UE as described with respect to FIG. 4A, a second UE as described with respect to FIG. 4B, a base station as described with respect to FIG. 4C, a third UE as described with respect to FIG. 4D, a fourth UE as described with respect to FIG. 4E, or a base station as described with respect to FIG. 4F.

In some implementations, the one or more memories 502 and the computer program codes 503 may be configured to, with the one or more processors 501, cause the apparatus 500 at least to perform any operation of the method as described in connection with FIG. 4A. In other implementations, the one or more memories 502 and the computer program codes 503 may be configured to, with the one or more processors 501, cause the apparatus 500 at least to perform any operation of the method as described in connection with FIG. 4B. In other implementations, the one or more memories 502 and the computer program codes 503 may be configured to, with the one or more processors 501, cause the apparatus 500 at least to perform any operation of the method as described in connection with FIG. 4C. In other implementations, the one or more memories 502 and the computer program codes 503 may be configured to, with the one or more processors 501, cause the apparatus 500 at least to perform any operation of the method as described in connection with FIG. 4D. In other implementations, the one or more memories 502 and the computer program codes 503 may be configured to, with the one or more processors 501, cause the apparatus 500 at least to perform any operation of the method as described in connection with FIG. 4E. In other implementations, the one or more memories 502 and the computer program codes 503 may be configured to, with the one or more processors 501, cause the apparatus 500 at least to perform any operation of the method as described in connection with FIG. 4F. Alternatively or additionally, the one or more memories 502 and the computer program codes 503 may be configured to, with the one or more processors 501, cause the apparatus 500 at least to perform more or less operations to implement the proposed methods according to the exemplary embodiments of the present disclosure.

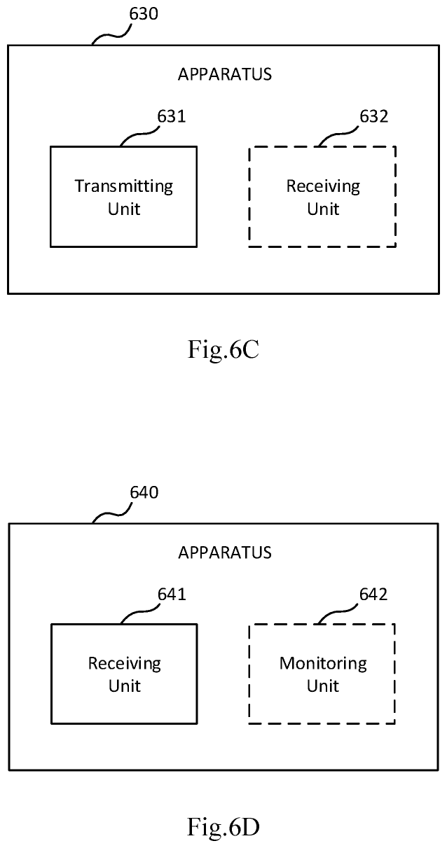

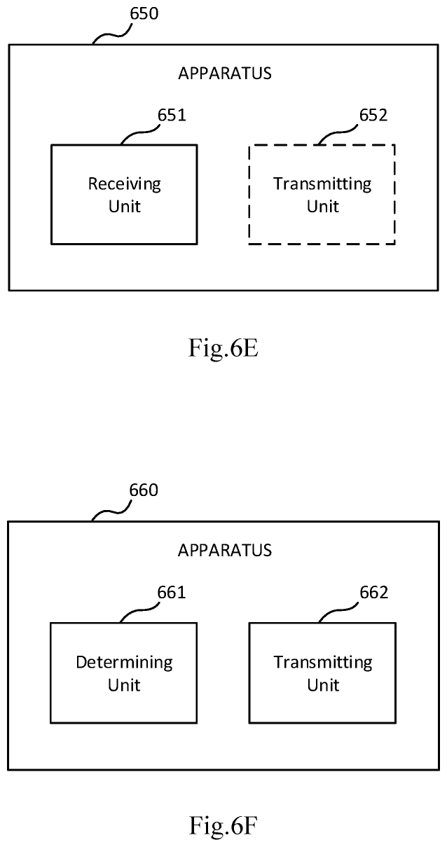

FIG. 6A is a block diagram illustrating an apparatus 610 according to some embodiments of the present disclosure. As shown in FIG. 6A, the apparatus 610 may comprise a generating unit 611 and a transmitting unit 612. In an exemplary embodiment, the apparatus 610 may be implemented in a first UE. The generating unit 611 may be operable to carry out the operation in block 412, and the transmitting unit 612 may be operable to carry out the operation in block 414. Optionally, the generating unit 611 and/or the transmitting unit 612 may be operable to carry out more or less operations to implement the proposed methods according to the exemplary embodiments of the present disclosure.

FIG. 6B is a block diagram illustrating an apparatus 620 according to some embodiments of the present disclosure. As shown in FIG. 6B, the apparatus 620 may comprise a receiving unit 621 and a determining unit 622. In an exemplary embodiment, the apparatus 620 may be implemented in a second UE. The receiving unit 621 may be operable to carry out the operation in block 422, and the determining unit 622 may be operable to carry out the operation in block 424. Optionally, the receiving unit 621 and/or the determining unit 622 may be operable to carry out more or less operations to implement the proposed methods according to the exemplary embodiments of the present disclosure.

FIG. 6C is a block diagram illustrating an apparatus 630 according to some embodiments of the present disclosure. As shown in FIG. 6C, the apparatus 630 may comprise a transmitting unit 631 and optionally a receiving unit 632. In an exemplary embodiment, the apparatus 630 may be implemented in a base station (e.g., a gNB, etc.). The receiving unit 632 may be operable to carry out the operation in block 432, and the transmitting unit 631 may be operable to carry out the operation in block 434. Optionally, the transmitting unit 631 and/or the receiving unit 632 may be operable to carry out more or less operations to implement the proposed methods according to the exemplary embodiments of the present disclosure.

FIG. 6D is a block diagram illustrating an apparatus 640 according to some embodiments of the present disclosure. As shown in FIG. 6D, the apparatus 640 may comprise a receiving unit 641 and optionally a monitoring unit 642. In an exemplary embodiment, the apparatus 640 may be implemented in a third UE. The receiving unit 641 may be operable to carry out the operation in block 442, and the monitoring unit 642 may be operable to carry out the operation in block 444. Optionally, the receiving unit 641 and/or the monitoring unit 642 may be operable to carry out more or less operations to implement the proposed methods according to the exemplary embodiments of the present disclosure.

FIG. 6E is a block diagram illustrating an apparatus 650 according to some embodiments of the present disclosure. As shown in FIG. 6E, the apparatus 650 may comprise a receiving unit 651 and optionally a transmitting unit 652. In an exemplary embodiment, the apparatus 650 may be implemented in a fourth UE. The receiving unit 651 may be operable to carry out the operation in block 452, and the transmitting unit 652 may be operable to carry out the operation in block 454. Optionally, the receiving unit 651 and/or the transmitting unit 652 may be operable to carry out more or less operations to implement the proposed methods according to the exemplary embodiments of the present disclosure.

FIG. 6F is a block diagram illustrating an apparatus 660 according to some embodiments of the present disclosure. As shown in FIG. 6F, the apparatus 660 may comprise a determining unit 661 and a transmitting unit 662. In an exemplary embodiment, the apparatus 660 may be implemented in a base station (e.g., a gNB, etc.). The determining unit 661 may be operable to carry out the operation in block 462, and the transmitting unit 662 may be operable to carry out the operation in block 464. Optionally, the determining unit 661 and/or the transmitting unit 662 may be operable to carry out more or less operations to implement the proposed methods according to the exemplary embodiments of the present disclosure.

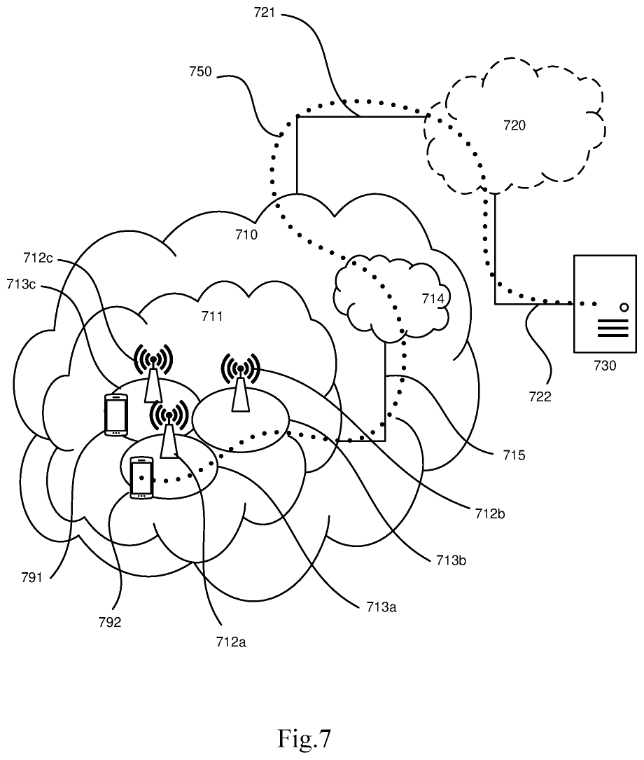

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

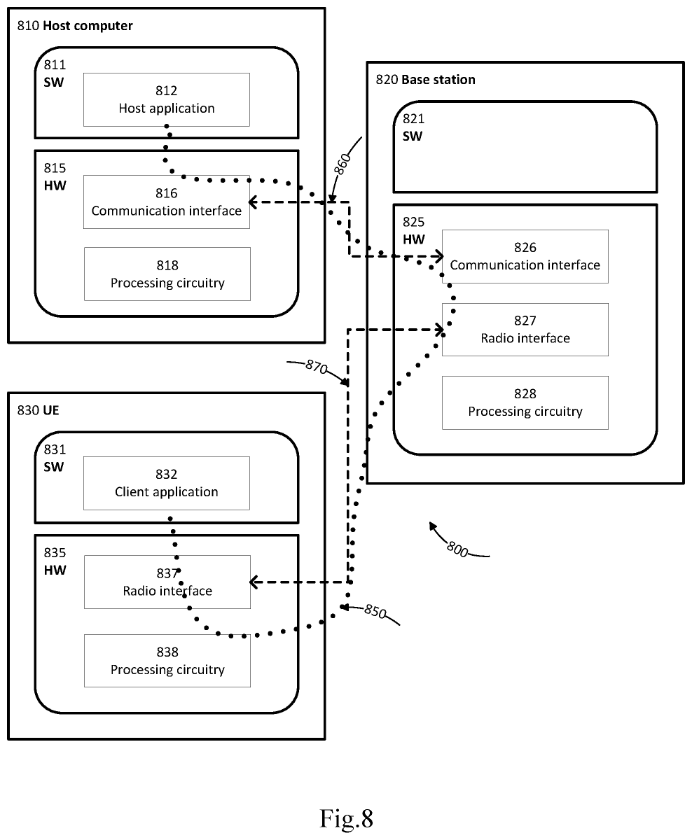

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

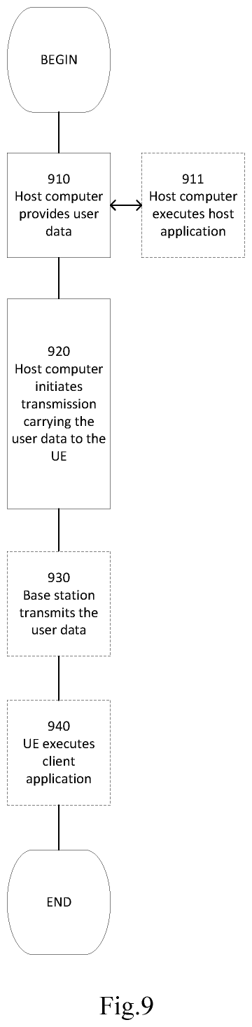

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

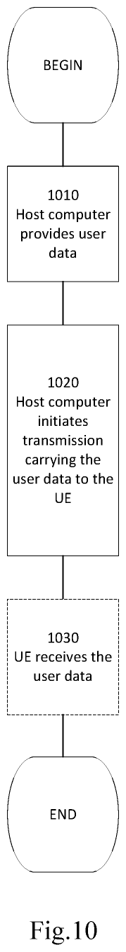

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

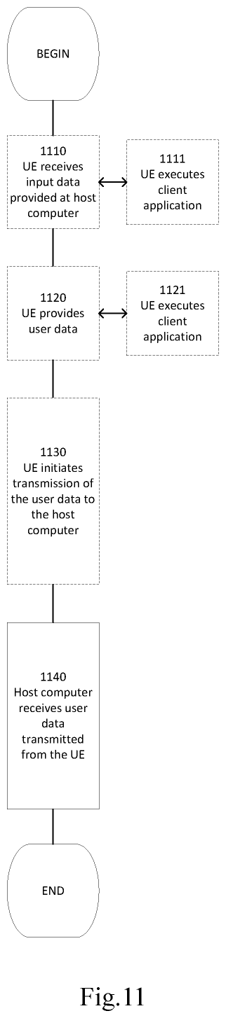

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

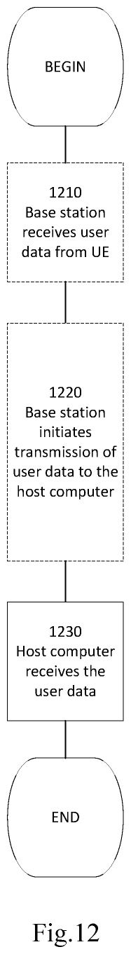

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 430 as described with respect to FIG. 4C, or any step of the exemplary method 460 as described with respect to FIG. 4F.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 430 as described with respect to FIG. 4C, or any step of the exemplary method 460 as described with respect to FIG. 4F.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 410 as described with respect to FIG. 4A, or any step of the exemplary method 420 as described with respect to FIG. 4B, or any step of the exemplary method 440 as described with respect to FIG. 4D, or any step of the exemplary method 450 as described with respect to FIG. 4E.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 410 as described with respect to FIG. 4A, or any step of the exemplary method 420 as described with respect to FIG. 4B, or any step of the exemplary method 440 as described with respect to FIG. 4D, or any step of the exemplary method 450 as described with respect to FIG. 4E.

According to some exemplary embodiments, there is provided a method implemented in a communication system which may include a host computer, a base station and a UE. The method may comprise, at the host computer, receiving user data transmitted to the base station from the UE which may perform any step of the exemplary method 410 as described with respect to FIG. 4A, or any step of the exemplary method 420 as described with respect to FIG. 4B, or any step of the exemplary method 440 as described with respect to FIG. 4D, or any step of the exemplary method 450 as described with respect to FIG. 4E.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 410 as described with respect to FIG. 4A, or any step of the exemplary method 420 as described with respect to FIG. 4B, or any step of the exemplary method 440 as described with respect to FIG. 4D, or any step of the exemplary method 450 as described with respect to FIG. 4E.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 430 as described with respect to FIG. 4C, or any step of the exemplary method 460 as described with respect to FIG. 4F.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 430 as described with respect to FIG. 4C, or any step of the exemplary method 460 as described with respect to FIG. 4F.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a first user equipment, UE, comprising:
generating first frequency information, wherein the first frequency information indicates one or more frequencies of the first UE; and
transmitting the first frequency information to a second UE.

2. The method according to claim 1, wherein the first frequency information is transmitted to the second UE in a discovery message.

3. The method according to claim 1, wherein when the first UE is linked to the second UE, the first frequency information is transmitted to the second UE proactively or in response to a request from the second UE.

4. The method according to claim 1, wherein the first UE operates as a remote UE, and the second UE operates as a relay UE for the first UE.

5. The method according to claim 4, wherein the one or more frequencies of the first UE comprise one or more of:
one or more Uu frequencies which the first UE camps on when the first UE is in a radio resource control, RRC, idle/inactive state; and
one or more Uu frequency bands which the first UE is able to support for paging.

6. The method according to claim 4, further comprising receiving, from the second UE, one or more of:
second frequency information indicating one or more frequencies of the second UE;
an indication of whether the one or more frequencies of the first UE are overlapped with the one or more frequencies of the second UE;
an indication of whether the second UE is able to monitor paging for the first UE; and
an indication of one or more frequencies in which the second UE is able to monitor the paging for the first UE.

7. The method according to claim 6, wherein the one or more frequencies of the second UE comprise one or more of:
one or more Uu frequencies which the second UE operates on; and
one or more Uu frequency bands which the second UE is able to support for paging.

8. The method according to claim 4, further comprising:
deprioritizing the second UE in relay selection or reselection by the first UE, when the one or more frequencies of the first UE are not overlapped with one or more frequencies of the second UE.

9. The method according to claim 4, further comprising:
triggering a relay reselection procedure to select another relay UE for the first UE and/or a cell reselection procedure to select a cell for the first UE, when the second UE is not able to monitor paging for the first UE.

10. The method according to claim 9, further comprising:
transmitting event information to the second UE, wherein the event information indicates that no other relay UE being able to monitor the paging for the first UE is selected by using the relay reselection procedure, and/or that no cell is selected for the first UE by using the cell reselection procedure.

11. The method according to claim 9, further comprising:
entering an RRC connected state from an RRC idle/inactive state, when an event persists for a predetermined period, wherein the event includes that no other relay UE being able to monitor the paging for the first UE is selected by using the relay reselection procedure, and/or that no cell is selected for the first UE by using the cell reselection procedure.

12. The method according to claim 11, further comprising transmitting, to a base station, information about one or more of:
whether the first UE is able to find a relay UE which is able to monitor paging for the first UE and has PC5 link quality higher than a first threshold;
whether the first UE is able to find a cell which has Uu link quality higher than a second threshold; and
whether one or more relay UEs included in a measurement report of the first UE are able to monitor the paging for the first UE.

13. The method according to claim 4, further comprising:
receiving, from a base station, information about a first list of relay UEs and/or a second list of relay UEs, wherein the first list of relay UEs include one or more relay UEs available for the first UE in an RRC idle/inactive state, and the second list of relay UEs include one or more relay UEs not available for the first UE in an RRC idle/inactive state.

14-26. (canceled)

27. A method performed by a second user equipment, UE, comprising:
receiving first frequency information from a first UE, wherein the first frequency information indicates one or more frequencies of the first UE; and
determining the one or more frequencies of the first UE, according to the first frequency information.

28-67. (canceled)

68. A method performed by a third user equipment, UE, comprising:
receiving configuration information from a base station, wherein the configuration information indicates one or more predetermined frequencies in which a fourth UE is to be paged via the third UE.

69. The method according to claim 68, further comprising:
receiving, from the fourth UE, a first indication of whether the fourth UE performs a reselection from a relay UE to a cell or from a cell to a relay UE; and
forwarding the first indication from the fourth UE to the base station.

70. The method according to claim 68, further comprising:
monitoring paging for the fourth UE in the one or more predetermined frequencies, when the third UE operates as a relay UE for the fourth UE and is able to monitor the paging in the one or more predetermined frequencies.

71. The method according to claim 68, further comprising:
transmitting, to the fourth UE, a second indication of whether the third UE is able to monitor paging for the fourth UE in the one or more predetermined frequencies, and/or a third indication of one or more frequencies in which the third UE is able to monitor the paging for the fourth UE.

72. The method according to claim 68, wherein when the third UE is not able to monitor paging for the fourth UE in the one or more predetermined frequencies, the method further comprises:
receiving event information from the fourth UE, wherein the event information indicates that no other relay UE being able to monitor the paging for the fourth UE is selected by using a relay reselection procedure of the fourth UE, and/or that no cell is selected for the fourth UE by using a cell reselection procedure of the fourth UE.

73. The method according to claim 72, further comprising:
starting to monitor the paging for the fourth UE in the one or more predetermined frequencies, when the third UE becomes to be capable of monitoring the paging in the one or more predetermined frequencies.

74-106. (canceled)
